(19) United States
(12) Patent Application Publication
(10) Pub. No.: US 2015/0287264 A1
(43) Pub. Date: Oct. 8, 2015

(54) GAMING MACHINE AND METHODS OF PLAYING A GAME INCLUDING A SKILL-BASED GAME

(71) Applicant: Zitro IP S. ar. I., Luxembourg (LU)

(72) Inventor: Johnny De Viveiros Ortiz, Madrid (ES)

(73) Assignee: Zitro IP S. ar. I., Luxembourg (LU)

(21) Appl. No.: 14/243,293

(22) Filed: Apr. 2, 2014

(51) Int. Cl. G07F 17/32

(52) U.S. Cl. CPC G07F 17/3211; G07F 17/3244

(57) ABSTRACT

A gaming machine for providing a skill-based game to a player is described herein. The gaming machine includes a display device and a controller. The controller displays a game that includes a primary wagering game and a secondary skill-based game. The controller randomly generates a primary game outcome of the primary wagering game, detects a triggering condition during the primary wagering game, and responsively displays the secondary skill-based game. The controller receives a wager associated with the secondary skill-based game from the player, receives a skill input from the player, responsively generates a secondary game outcome of the secondary skill-based game as a function of the received skill input, and provides an award to the player as a function of the secondary game outcome. The award includes wagering credits for use in placing a wager in the primary wagering game.

### COPYRIGHT NOTICE

The figures included herein contain material that is subject to copyright protection. The copyright owner has no objection to the facsimile reproduction by anyone of this patent document as it appears in the U.S. Patent and Trademark Office, patent file or records, but reserves all copyrights whatsoever in the subject matter presented herein.

### TECHNICAL FIELD

The subject matter disclosed herein relates generally to gaming machines and more particularly, to an apparatus and method for allowing players to play a wagering game with a bonus game including a skill-based target game.

### BACKGROUND OF THE INVENTION

At least some known gaming machines display video based wagering game such as bingo-type games that allow players to play a game and wager on the outcome of the game. During play of known video bingo-type games, the player purchases one or more bingo-type cards for use in playing the bingo-type game. Each bingo card includes a randomly selected sub-set of numbers from a pre-defined set of numbers. The gaming machine conducts a draw wherein the gaming machine randomly selects a plurality of numbers from the predefined set of numbers. During the draw, the gaming machine or the player compare the drawn number with the numbers displayed on the player's bingo cards to determine if a match occurs on the bingo cards. The player and/or gaming machine mark, or daub, each corresponding number on the player's card matching a selected number. The gaming machine provides an award to the player if a predefined number of matches occur in the player's card and/or if the matched numbers form a predefined pattern on the player's card.

Over time, during game play, the player may become frustrated because the chances of receiving an award are based only on the number of matches made between the numbers selected during the draw and the predefined set of numbers displayed in the player's bingo card. Accordingly, new features are necessary to appeal to player interest and enhance excitement in order to entice longer play and increased profitability. The present invention is directed to satisfying these needs.

### SUMMARY OF THE INVENTION

According to one aspect of the present invention, a wagering game system hereinafter an electronic gaming system, is configured to carry on at least a main game whilst performing the necessary actions to provide a bonus game on a display on the electronic gaming system.

The wagering game system or electronic gaming system is configured to conduct a wagering game that itself includes at least one display device and at least one user input device, as well as one or more processors operatively associated with the wagering game machine. The one or more processors are configured to perform, responsive to instructions stored on one or more physical memory devices, the acts of randomly determining an outcome of a base wagering game, determining if a trigger condition for a skill-based game feature is satisfied by the outcome of the base wagering game, providing an option to accept the skill-based game feature or to decline the skill-based game feature in favor of a non-skill based game feature, and executing the skill-based game feature responsive to an instruction to accept the skill-based game feature.

The embodiments of the present invention are directed to systems and methods for providing a combined skill-based and wagering bonus game on an electronic device, such as an electronic gaming machine (EGM) or other electronic platform. The user input for directing or controlling the selected item in the skill-based game may include signals received from any communication device, including depressible buttons, joysticks, controllers, touch-enabled display screens or the like.

In a preferred embodiment, the invention is directed to a method of providing a bonus game in addition to an underlying game through an EGM having a processor, memory, communication device and display device, the bonus game including the steps of: providing a display of a plurality of items; receiving a user selection relating to one of the plurality of items; displaying the selected item as part of an at least partially skill-based target game, wherein one or more targets are displayed; receiving user input relating to movement of the selected item in the skill-based target game; displaying simulated movement of the selected item pursuant to the user input received to reveal an outcome of the skill-based target game in which the selected item is displayed as either contacting a target or not contacting a target.

The aforementioned method further may include displaying a simulated two-dimensional or three-dimensional environment in which the target game is played. The selected items and one or more targets may be displayed as two or three dimensional objects in the target game environment.

Depending on the outcome of the target game the aforementioned method may include the step of providing an award of credits in the underlying game. The credits in the underlying game may be used to activate a bonus game after a preset amount of the credits is achieved whilst the aforementioned method may provide a wager of at least a portion of credits earned in the underlying game, wherein the wager is resolved by the outcome of the target game.

In some embodiments, the aforementioned method further includes the step of receiving a portion of credits in return for a selection of an item. Each item of the plurality may be associated with a different purchase price which requires receiving a corresponding amount of credits for use of the item in the target game. The target game may be any simulated game in which a user may attempt to direct an item to contact a target such as, for example, a throwing game, a shooting game, a launching game, an archery game, a bowling game, and/or a jumping game. The user input for controlling the simulated movement may involve directing the simulated angle, velocity, force or direction of movement in a two-dimensional or three-dimensional environment.

In some embodiments, the aforementioned method further includes the step of displaying a plurality of targets in the target game, wherein each target of the plurality of targets may be associated with a different award or credit amount and each item may be associated with different characteristics of simulated movement in the target game. The award is determined at least partially by the selected item and specific target the selected item contacts.

The invention is also directed to an electronic game system for providing methods as described above, which may be partially or wholly carried out in a variety of ways and/or through a variety of systems and devices, which may include, but are not limited to, an EGM for one or more players, standalone multiplayer platforms which may include a player interface such as a touch screen display, through a home computer or portable computing device, such as a tablet computer or mobile phone capable of communicating with a network or over the Internet, global telecommunication network or world wide web. An EGM of the invention may include one or more processing devices in communication with a database or memory device, data input/output device and display device. The memory device may include data relating to the underlying game and embodiments of the invention as described herein, such as the selected items and skill-based target game, and the processing device may facilitate simulation of movement. The display device may display the items and simulations as described herein and the data input/output device may accept wagers and provide awards.

In one aspect of the present invention, a method of allowing a player to play a game on a gaming device is provided. The method includes allowing a player to make a wager associated with a primary wagering game, responsively displaying the primary wagering game on the display device, randomly generating an outcome of the primary wagering game, and providing a primary game award to the player as a function of the primary wagering game outcome. The method also includes displaying a secondary skill-based game on the display device including a plurality of targets and a plurality of player-selectable items for use in contacting the plurality of targets, allowing the player to select at least one item from the plurality of player-selectable items, allowing the player to select a movement associated with the selected item, determining an outcome of the secondary skill-based game as a function of the selected item and the selected item movement, and displaying the secondary skill-based game outcome including a simulated movement of the selected item in which the selected item is displayed as either contacting a target or not contacting a target.

In another aspect of the present invention, a gaming machine displaying a game is provided. The gaming machine includes a display device, a user input device for generating a signal indicative of a player's selection input, and a controller for allowing a player to make a wager associated with a primary wagering game, displaying the primary wagering game on the display device, randomly generating an outcome of the primary wagering game, and providing a primary game award to the player as a function of the primary wagering game outcome. The controller also displays a secondary skill-based game on the display device including a plurality of targets and a plurality of player-selectable items for use in contacting the plurality of targets, allows the player to select at least one item from the plurality of player-selectable items, allows the player to select a movement associated with the selected item, determines an outcome of the secondary skill-based game as a function of the selected item and the selected item movement, and displays the secondary skill-based game outcome including a simulated movement of the selected item in which the selected item is displayed as either contacting a target or not contacting a target.

In yet another aspect of the present invention, a system is provided. The system includes a plurality of gaming devices and a system controller. Each gaming device includes a user input device for accepting a player's selection input and a display device. The system controller is coupled to each gaming device for displaying a game on at least one gaming device. The system controller allows a player to make a wager associated with a primary wagering game, displays the primary wagering game on the display device, randomly generates an outcome of the primary wagering game, and provides a primary game award to the player as a function of the primary wagering game outcome. The system controller also displays a secondary skill-based game on the display device including a plurality of targets and a plurality of player-selectable items for use in contacting the plurality of targets, allows the player to select at least one item from the plurality of player-selectable items, allows the player to select a movement associated with the selected item, determines an outcome of the secondary skill-based game as a function of the selected item and the selected item movement, and displays the secondary skill-based game outcome including a simulated movement of the selected item in which the selected item is displayed as either contacting a target or not contacting a target.

In yet another aspect of the present invention, a method of allowing a player to play a game on a gaming device is provided. The method includes the steps of allowing a player to make a wager associated with a skill-based game and responsively displaying the skill-based game on the display device including a plurality of targets and a plurality of player-selectable items for use in contacting the plurality of targets. The method also includes allowing the player to purchase at least one item from the plurality of player-selectable items using the wager, allowing the player to select a movement associated with the selected item, determining an outcome of the skill-based game as a function of the purchased item and the selected item movement, displaying the skill-based game outcome including a simulated movement of the selected item in which the selected item is displayed as either contacting a target or not contacting a target, and providing an award to the player as a function of the skill-based game outcome.

In one aspect of the present invention, a method of allowing a player to play a game on a gaming device is provided. The method includes allowing a player to make a wager associated with a primary wagering game, responsively displaying the primary wagering game on the display device, randomly generating an outcome of the primary wagering game, and providing a primary game award to the player as a function of the primary wagering game outcome. The method also includes displaying a secondary skill-based game on the display device.

In another aspect of the present invention, a gaming machine displaying a keno-type game is provided. The gaming machine includes a display device, a user input device for generating a signal indicative of a player's selection input, and a controller for allowing a player to make a wager associated with a primary wagering game, displaying the primary wagering game on the display device, randomly generating an outcome of the primary wagering game, and providing a primary game award to the player as a function of the primary wagering game outcome. The controller also displays a secondary skill-based game on the display device including a platform game and a plurality of player-contactable used for a bet game, wherein the bet game comprises betting on the content of the item. In a preferred embodiment of the present invention the skill-based game is a platform game based on “jack and the beanstalk” where a player climbs the beanstalk while the screen scrolls vertically and the items are chests that randomly displayed on the screen.

In yet another aspect of the present invention, a method of allowing a player to play a game on a gaming device is provided. The method includes the steps of allowing a player to make a wager associated with a skill-based game and responsively displaying the skill-based game on the display device including platform game comprising randomly arranged items a betting game for use in contacting the plurality of platforms. The method also includes allowing the player to bet on the content of at least one item from the plurality of player-selectable items, determining an outcome of the betting game as a function of the content of the item, displaying the skill-based game outcome including a simulated movement of the opened item in which the content of the item is displayed and providing an award to the player as a function of the bet game outcome.

In one aspect of the present invention, a method of allowing a player to play a game on a gaming device is provided. The gaming device includes a processor in communication with a display device. The method includes the steps of allowing a player to make a wager associated with a primary wagering game and responsively displaying the primary wagering game on the display device, generating an outcome of the primary wagering game, providing a primary game award to the player as a function of the primary wagering game outcome, and displaying an option to trigger a secondary skill-based game on the display device once the primary wagering game outcome reaches a threshold value. The secondary skill-based game includes a platform game. The platform game allows the player to move at least one selectable character through at least one vertically arranged level by sending a command wherein the command comprises a reduction in the wagering outcome. The method also includes generating random items along the levels. The items include wagering credits. The method includes providing a wagering outcome comprised in an item when the selectable character contacts the item. In addition, the method may include displaying a betting game including betting on the content of an item, opening the item, and collecting credits contained in the item. Each item of the plurality of items is associated with a different characteristic of simulated movement. The method may also include determining if a triggering condition occurs in the primary wagering game outcome and responsively displaying the secondary skill-based game based on the occurrence of the triggering condition. The primary wagering game award includes an amount of wagering credits. The triggering condition may be defined as a predefined amount of wagering credits being accumulated during the primary game. The primary wagering game may include a plurality of game symbols being displayed on the display device and the triggering condition may be defined as an appearance of a special symbol in the primary game outcome. The primary game wager may also include wagering credits. The method may include allowing the player to use wagering credits in the betting game. The method may also include stopping the secondary skill-based game if a player selection input indicative of a player's selection of the character movement is not received within an elapsed predefined period of time since the player's selection of the player selectable item.

In another aspect of the present invention, a gaming machine for displaying a game to a player is provided. The gaming machine includes a display device, a user input device configured to generate a signal indicative of a player's selection input, and a controller coupled to the display device and the user input device. The controller allows a player to make a wager associated with a primary wagering game, displays the primary wagering game on the display device, generates an outcome of the primary wagering game, and provides a primary game award to the player as a function of the primary wagering game outcome. The controller may also display a secondary skill-based game on the display device including a platform game. The controller allows the player to move a character along the platforms, allows the player to select a movement associated with an item arranged along the platforms, and determines an outcome of the secondary skill-based game. The controller is also operative to additionally generate a bet game as a function of a bet on the content of the item arranged in the secondary skill-based game when the player contacts the item and before determining its content.

In one aspect of the present invention, a gaming machine for providing a skill-based game to a player is provided. The gaming machine includes a display device for displaying a game to a player and a controller coupled to the display device. The game includes a primary wagering game and a secondary skill-based game. The controller is configured to randomly generate a primary game outcome of the primary wagering game, display the primary game outcome on the display device, detect a triggering condition during the primary wagering game, and responsively display the secondary skill-based game. The controller receives a wager being associated with the secondary skill-based game from the player, receives a skill input from the player, responsively generates a secondary game outcome of the secondary skill-based game as a function of the received skill input, and provides an award to the player as a function of the secondary game outcome. The award includes wagering credits for use in placing a wager in the primary wagering game.

In another aspect of the present invention, a method of providing a skill-based game to a player via a gaming machine including a display device and a processor is provided. The method includes the steps of displaying a game includes a primary wagering game and a secondary skill-based game, randomly generating a primary game outcome of the primary wagering game, detecting a triggering condition during the primary wagering game, and responsively displaying the secondary skill-based game. The method also includes receiving a wager being associated with the secondary skill-based game from the player, receiving a skill input from the player, responsively generating a secondary game outcome of the secondary skill-based game as a function of the received skill input, and providing an award to the player as a function of the secondary game outcome. The award includes wagering credits for use in placing a wager in the primary wagering game.

In a further aspect of the present invention, one or more non-transitory computer-readable storage media, having computer-executable instructions embodied thereon is provided. The computer-executable instructions cause a processor to display a game including a primary wagering game and a secondary skill-based game, randomly generate a primary game outcome of the primary wagering game, detect a triggering condition during the primary wagering game, and responsively display the secondary skill-based game. The computer-executable instructions also cause the processor to receive a wager being associated with the secondary skill-based game from the player, receive a skill input from the player, responsively generate a secondary game outcome of the secondary skill-based game as a function of the received skill input, and provide an award to the player as a function of the secondary game outcome. The award includes wagering credits for use in placing a wager in the primary wagering game.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a schematic view of an exemplary gaming machine of the present invention;

FIG. 2 is another schematic representation of the gaming machine shown in FIG. 1;

FIG. 3 is a flowchart of a method that may be used with the gaming machine shown in FIG. 1 for allowing a player to play a wagering game and a skill-based game on the gaming machine, according to an embodiment of the present invention;

FIG. 4 is an exemplary entertaining graphical display of a bingo-type game that may be played with the gaming machine shown in FIG. 1, according to an embodiment of the present invention;

FIG. 5 is an exemplary entertaining graphical display of a skill-based game that may be played with the gaming machine shown in FIG. 1, according to an embodiment of the present invention;

FIG. 6 is an exemplary entertaining graphical display of an item selection screen, according to an embodiment of the present invention;

FIG. 7 is an exemplary entertaining graphical display of an item launching device that may be used with the skill-based game shown in FIG. 5;

FIGS. 8-10 are schematic views of the item launching device shown in FIG. 7;

FIG. 11 is an exemplary entertaining graphical display of an item purchase screen, according to an embodiment of the present invention;

FIG. 12 is a schematic view of an exemplary system of the present invention;

FIG. 13 is a schematic representation of a gaming controller that may be used with the gaming machine shown in FIG. 1;

FIG. 14 is a flowchart of a method that may be used with the gaming machine shown in FIG. 1 for allowing a player to play a skill-based game via the gaming machine, according to an embodiment of the invention;

FIG. 15 is an exemplary entertaining graphical display of a bingo-type game that may be used with the method shown in FIG. 14, according to an embodiment of the present invention;

FIGS. 16-19 are exemplary entertaining graphical displays of a skill-based game that may be used with the method shown in FIG. 14, according to an embodiment of the present invention; and

FIG. 20 is a schematic representation of a gaming device for allowing a player to play a bingo-type game including a secondary game, according to an embodiment of the invention.

Corresponding reference characters indicate corresponding parts throughout the drawings.

### DETAILED DESCRIPTION OF THE PREFERRED EMBODIMENT

With reference to the drawings and in operation, the invention overcomes at least some of the disadvantages of known gaming machines by providing, among other things, systems and methods which enable a player to place a wager on a skill-based game and receive an award that may be used to place a wager on another non-skill based game. For example, the system and methods of the invention are configured to allow the player to play a bingo-type wagering game that includes a bonus feature skill-based game and that allows the player to receive an enhanced award based on the outcome of the skill-based game. More specifically, the system and methods of the present invention allow the player to place a wager on the outcome of the skill-based game and interact with the skill-based game to affect the game outcome, and provide an award to the player based on the outcome of the skill-based game and the player's wager. In addition, the player may place a wager on the bingo-type game using the award provided in the skill-based game. By providing a bingo-type game that includes a bonus feature skill-based game that provides an award to the player that may be used for wagering on the bingo-type game, the player's expectation for achieving a win is increased and the enjoyment of the game is improved. Thus, the amount of time that the game is played by patrons of a gaming establishment is thereby increased.

The invention is generally directed to systems and methods to promote and enhance game play by allowing a player to place a wager on a primary game such as, for example, a bingo-type game, receive an award based on the outcome of the primary game, and allow a player to play a secondary skill-based game and to receive an award based on the outcome of the secondary skill-based game that may be used to wager on the primary game.

In some embodiments, the present invention includes system 10 that displays a bingo-type game, allows a player to make a wager associated with the bingo-type game, randomly generates an outcome of the bingo-type game and provides a primary game award to the player as a function of the bingo-type game outcome. The system 10 may also display a secondary skill-based game that includes a plurality of targets and a plurality of player-selectable items that are used to contact one or more targets. The system 10 allows the player to select an item and to select a movement associated with the item, and determines an outcome of the secondary skill-based game based on the player selected item and movement. The system 10 then displays the secondary skill-based game outcome including a simulated movement of the selected item in which the selected item is displayed as either contacting a target or not contacting a target. In one embodiment, the system 10 provides a secondary award of wagering credits to the player based on the secondary skill-based game outcome and allows the player to place a wager on the bingo-type game using the secondary award wagering credits.

In some embodiments, the skill-based game may include any game that allows the player to affect the outcome of the skill-based game through a series of player choices and/or player selections. The skill-based game may also include a player skill component associated with the player's selection that may include physical or manual dexterity, digital dexterity, hand-eye coordination (e.g., aim), reflexes, memory, cognitive processing, knowledge, and/or strategy-based selection. Skill-based games may include, but are not limited to including, target shooting games, catapult-type games, sporting games, memory games, matching games, and/or any suitable game that includes a skill component and that enables the outcome of the game to be at least partially determined based on a players selection.

According to one aspect of the present invention, a wagering game system hereinafter an electronic gaming system, is configured to carry on at least a main game whilst performing the necessary actions to provide a bonus game or skill based game with an optional betting game on a display on the electronic gaming system.

The present invention therefore if integrated into a game of chance as if it acts as an independent game may comprise three phases: Input Screen Show; Game Screen; Show output screen. When the game is on the input stage show the player may not take any action for the terminal. The main function of this phase is to differentiate between gambling and game.

During the game phase the player can perform the betting action for prizes, when a credit for betting is achieved or continue to participate in play. There is a possibility to continue playing the game without making any bets, but simply operating any action device, the device can be the same as is used for the bet. For example, to place the bet the player can use an available mechanical input device including the pushbutton panel of the machine, and may also have an element provisions touch screen terminal.

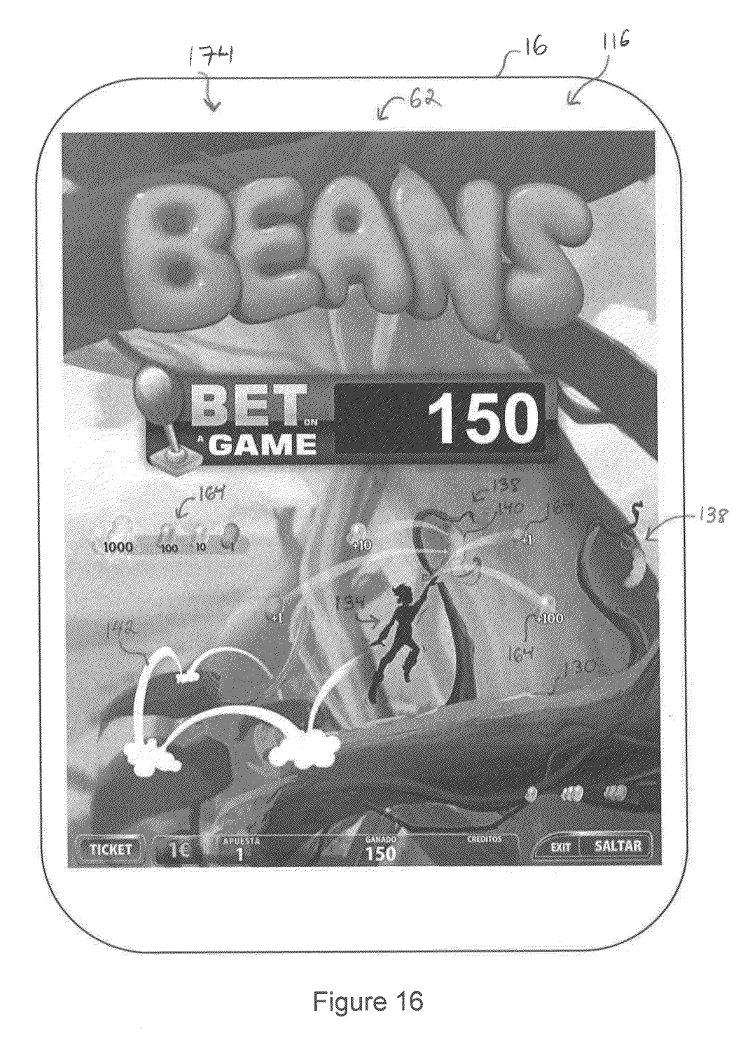

To participate in the game and therefore access the betting game you have to give two conditions must be activated Bet button on a Game, including 1) in a prominent position on the screen the player can activate the possibility to participate in the game; and 2.) with the “Bet on a Game” on, the player must get a random value determined at stake. For example to be able to get into the game the player will get a value X pattern regardless of prize money. When it meets the condition for entering the game mentioned “Bet on Game” above, “Bet on a Game” button (shown in FIG. 16) is highlighted to alert the player that they will be playing the game because they meet the necessary conditions for access.

During the skill-based game, the participant must guide a member through a scenario, in order to get different objects of different values. Each time the player decides to participate, the player will be making a bet on the game. A bet is provided to make a move and allow be able to get an award, based on the skill of the player. As long as the game “Bet on a Game” the player will be able to perform the following actions.

When the player presses a button that will be shown in a movement in the screen, every move will be linked to a bet. For example if the game is set in the branch of a giant where the constantly moving element is the figure of a boy, the player must overcome obstacles to steady the tree and in turn win prizes. Each time the player press a button to move the figure of the boy, the player will be making a bet.

In the skill based game and/or in the betting game triggered when the special items (chests) are contacted by the character; if the player performs no bet, and therefore does not attempt to dodge obstacles during game play, the player may lose and return to the base game. For example, the figure may be required to go through the tree and to jump to avoid an obstacle during the game. The player may in turn decide not to make any bet and the figure will fall directly to the base game screen, after passing a “show output”.

There is also the chance that the player loses in the game because it makes the element (game character) act too early or too late. In this case the end of the game is similar to the case explained above.

As the player progresses through the game “Bet on a Game”, the objects the player manages to catch will be exchanged for a prize. In the skill based game and betting game the character jumps and manages to open a pod from which come some beans, in this case on the same screen shows the plan Bet on gambling winnings to Game and every bean has a color that is associated with a prize value. At any time the player may terminate the game, in any case will proceed the counting of the achievements in the game. The terminal may have an output device for the player to end the game.

When the game ends and the game is integrated into a game of chance the game returns to the base game. If the game acts as a standalone game, the player will be returned to the beginning of the game. Providing credits to the machine by the player may occur depending on the interactions with the machine or only in terms of the elements that cause a draw and possible prize. In the first case, the interactions that lead but contributing draw credits to the machine will be returned in the same game the player by some mechanism, such as gifts

The game system or electronic gaming system is configured to conduct the wagering game, the skill-based game and the bet game. The system itself includes at least one display device and at least one user input device, as well as one or more processors operatively associated with the wagering game machine. The one or more processors are configured to perform, responsive to instructions stored on one or more physical memory devices, the acts of randomly determining an outcome of a base wagering game, determining if a trigger condition for a skill-based game feature is satisfied by the outcome of the base wagering game, providing an option to accept the skill-based game feature or to decline the skill-based game feature in favor of a non-skill based game feature, and executing the skill-based game feature responsive to an instruction to accept the skill-based game feature, providing a bet game when it is triggered in the skill-based game.

The embodiments of the present invention are directed to systems and methods for providing a combined skill-based/bet game and wagering bonus game on an electronic device, such as an electronic gaming machine (EGM) or other electronic platform. The user input for directing or controlling the selected item in the skill-based game may include signals received from any communication device, including depressible buttons, joysticks, controllers, touch-enabled display screens or the like.

In a preferred embodiment, the invention is directed to a method of providing a bonus game in addition to an underlying game through an EGM having a processor, memory, communication device and display device, the bonus game including the steps of: providing a display of a plurality of items; receiving a user selection relating to one of the plurality of items; displaying the selected item as part of an at least partially skill-based platform game, wherein one or more items are displayed; receiving user input relating to movement of the selected item in the skill-based platform game; displaying simulated movement of the selected item pursuant to the user input received to reveal an outcome of the skill-based platform game in which the selected item is displayed as moving along the platform game and not falling down plus a betting game triggered by contacting the items randomly arranged along the platform game.

The aforementioned method further may include displaying a simulated two-dimensional or three-dimensional environment in which the platform game is played. The selected items and one or more platforms may be displayed as two or three dimensional objects in the platform game environment.

Depending on the outcome of the platform game the aforementioned method may include the step of providing an award of credits in the underlying game. The credits in the underlying game may be used to activate a bonus game after a preset amount of the credits is achieved whilst the aforementioned method may provide a wager of at least a portion of credits earned in the underlying game, wherein the wager is resolved by the outcome of the platform game.

In some embodiments, the aforementioned method further includes the step of receiving a portion of credits in return for a selection of an item. Each item of the plurality may be associated with a different purchase price requiring receiving a corresponding amount of credits for use of the item in the platform game. The platform game may be any simulated game in which a user may attempt to direct an item to contact a platform, such as a throwing game, a shooting game, a launching game, an archery game, a bowling game, a jumping game. The user input for controlling the simulated movement may involve directing the simulated angle, velocity, force or direction of movement in a two-dimensional or three-dimensional environment.

In some embodiments, the aforementioned method further includes the step of displaying a plurality of platforms in the platform game, wherein each platform of the plurality of platforms may be associated with a different award or credit amount and each item may be associated with different characteristics of simulated movement in the platform game. The award is determined at least partially by the selected item and specific platform the selected item contacts.

The invention is also directed to an electronic game system for providing methods as described above, which may be partially or wholly carried out in a variety of ways and/or through a variety of systems and devices, which may include, but are not limited to, an EGM for one or more players, standalone multiplayer platforms which may include a player interface such as a touch screen display, through a home computer or portable computing device, such as a tablet computer or mobile phone capable of communicating with a network or over the Internet, global telecommunication network or world wide web. An EGM of the invention may include one or more processing devices in communication with a database or memory device, data input/output device and display device. The memory device may include data relating to the underlying game and embodiments of the invention as described herein, such as the selected items and skill-based platform game, and the processing device may facilitate simulation of movement. The display device may display the items and simulations as described herein and the data input/output device may accept wagers and provide awards.

A selected embodiment of the present invention will now be explained with reference to the drawings. It will be apparent to those skilled in the art from this disclosure that the following description of the embodiment of the present invention is provided for illustration only and not for the purpose of limiting the invention as defined by the appended claims and their equivalents.

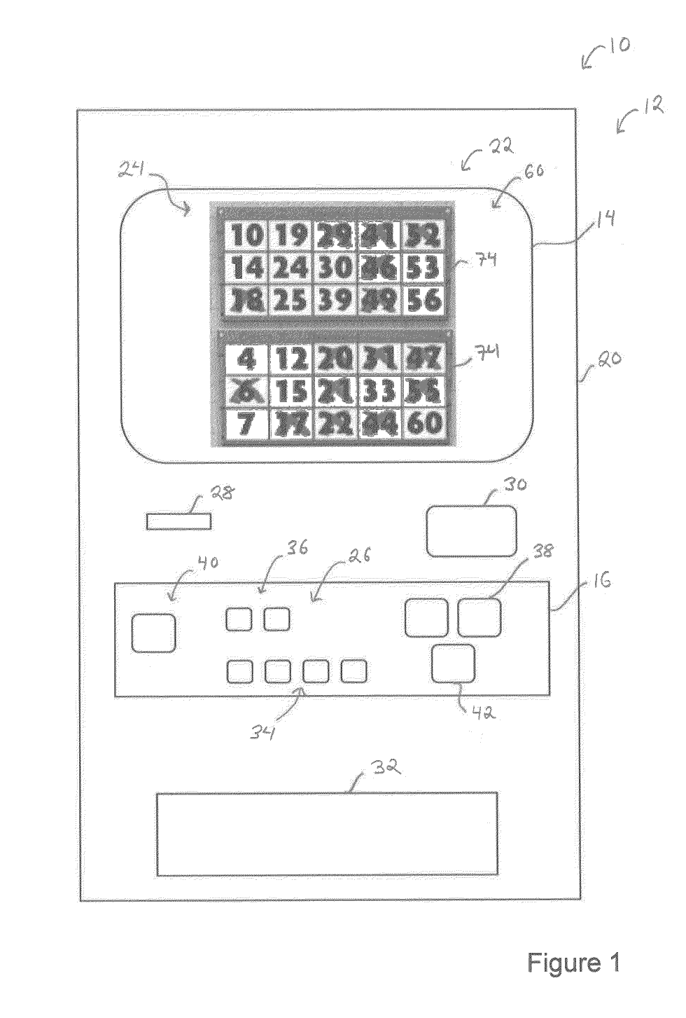

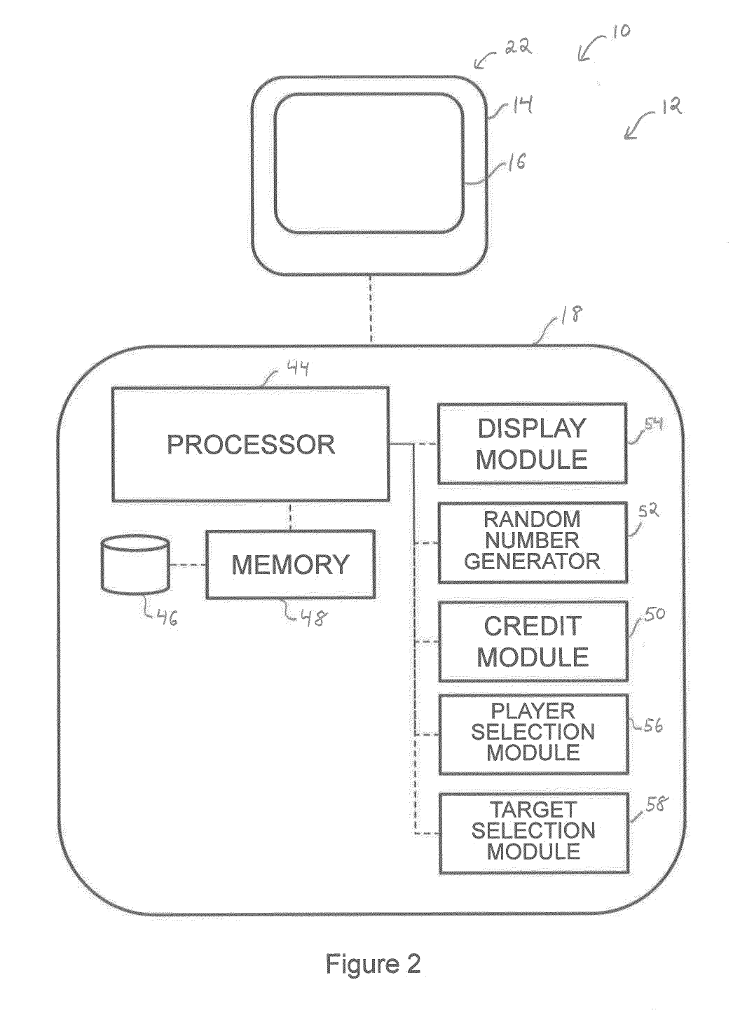

FIG. 1 is a perspective view of a gaming machine 12 that may be used with the system 10, according to an embodiment of the present invention. FIG. 2 is a schematic representation of the gaming machine 12. A preferred embodiment of the present invention is a video gaming machine preferably installed in a casino. In the illustrated embodiment, the gaming machine 12 includes the display device 14 for displaying a plurality of games, a user input device 16 to enable a player to interface with the gaming machine 12, and a gaming controller 18 that is operatively coupled to the display device 14 and the user input device 16 to enable a player to play games displayed on the display device 14. The gaming machine 12 may also includes a cabinet assembly 20 that is configured to support the display device 14, the user input device 16, and/or the gaming controller 18 from a supporting surface.

The display device 14 and the user input device 16 are coupled to the cabinet assembly 20 and are accessible by the player. In one embodiment, the gaming controller 18 is positioned within the cabinet assembly 20. Alternatively, the gaming controller 18 may be separated from the cabinet assembly 20, and connected to components of the gaming machine 12 through a network such as, for example, a local area network (LAN), a wide area network (WAN), dial-in-connections, cable modems, wireless modems, and/or special high-speed Integrated Services Digital Network (ISDN) lines.

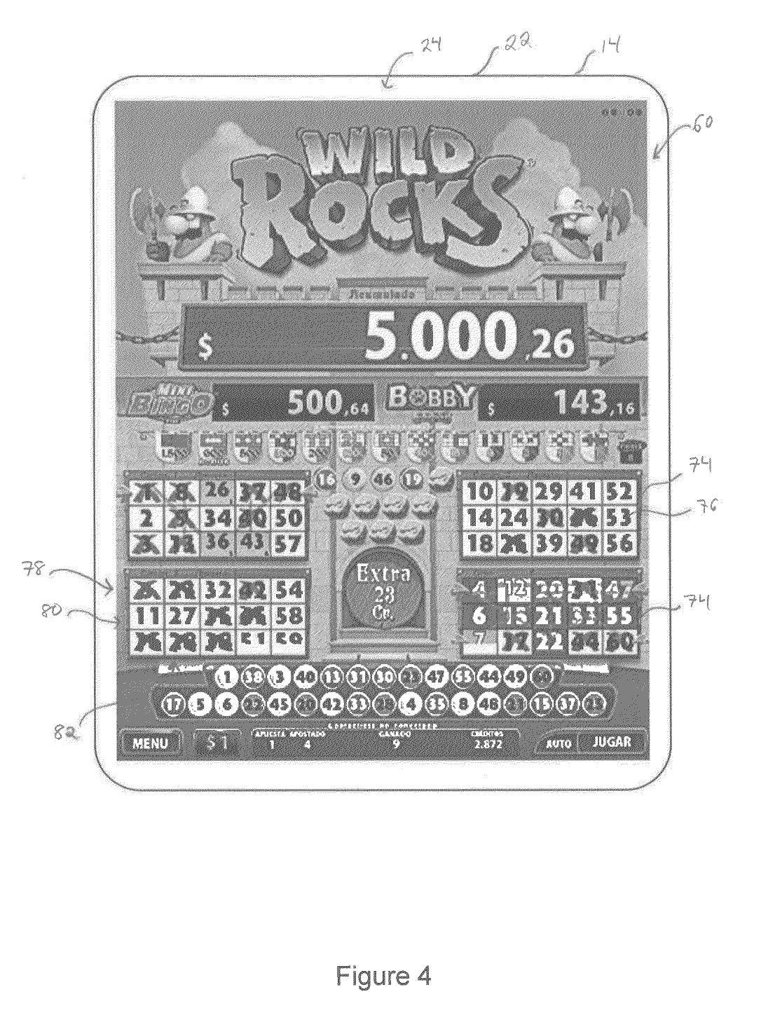

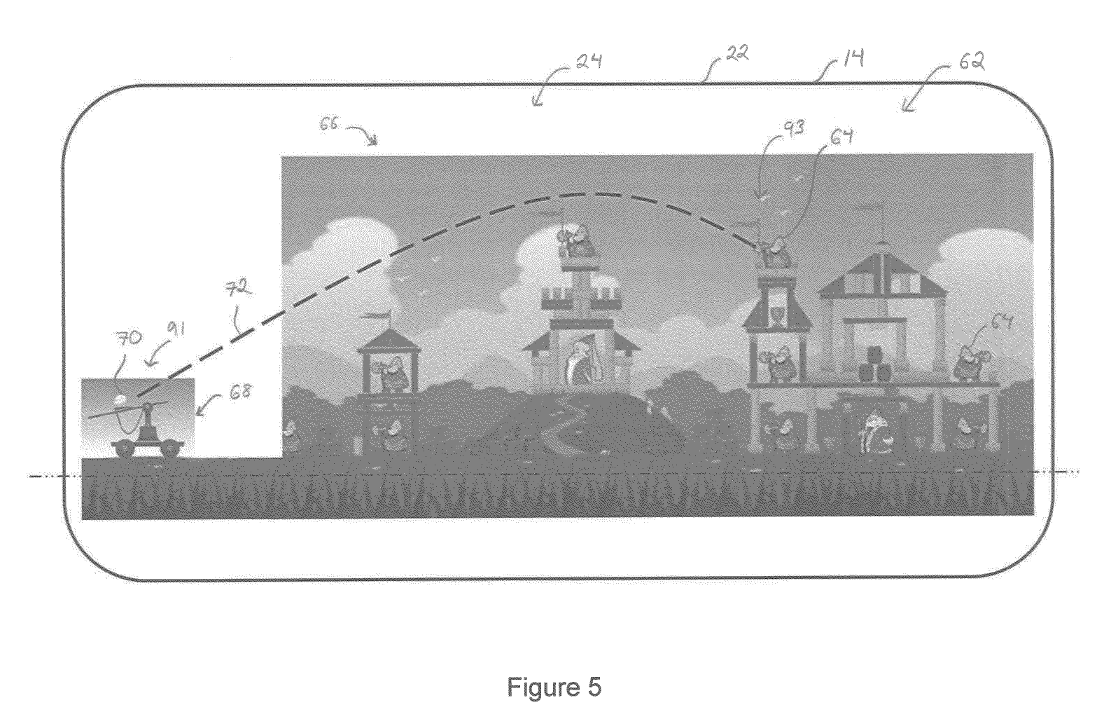

In the illustrated embodiment, the display device 14 includes a display 22 including a flat panel display, such as a cathode ray tube display (CRT), a liquid crystal display (LCD), a light-emitting diode display (LED), an organic light-emitting diode (OLED), an active-matrix organic light-emitting diode (AMOLED), a plasma display, and/or any suitable visual output device capable of displaying graphical data and/or text to a user. Alternatively, a single component, such as a touch screen, may function as both the display device 14 and as the user input device 16. In the illustrated embodiment, the display device 14 displays a game screen 24 (shown in FIGS. 4 and 5) including indicia and/or symbols for use in a game, e.g., symbols for a bingo game, cards used by a card game, roulette wheel and symbols used in a roulette game, reels used in a reel game, and items and target used in the target game. The game screen 24 may include any type of game including, but not limited to, a skill-based game such as a target game, a video bingo game, video keno game, a video slot game, a blackjack game, a video poker game, or any type of game which allows a player to make a wager, play a game, and potentially provide the player an award based on an outcome of the game. In addition, the display device 14 may display game play instructions for performing the game including, but not limited to, playing instructions, paytables, paylines, betting lines and/or any other information to enable the gaming machine 12 to function as described herein. Moreover, in one embodiment, the display device 14 may include a plurality of displays 22 that each are be configured to display at least a portion of the game screen 24 and/or game play instructions.

The user input device 16 includes a plurality of input buttons 26, a coin slot 28, a bill acceptor 30, and a coin tray 32 for dispensing coins to the player. In one embodiment, the input buttons 26 may include a plurality of BET switches 34 for inputting a wager on a game and selecting a number of rounds to be played during a gaming session, a plurality of selection switches 36 for allowing a player to select a plurality of game symbols, a CLEAR switch 38 for de-selecting player selected game symbols, a PAYOUT switch 40 for ending a gaming session and dispensing accumulated gaming credits to the player, and a start button, i.e., a DRAW switch 42 to initiate an output of a game. In addition, the user input device 16 may includes, for example, a keyboard, a pointing device, a mouse, a stylus, a touch sensitive panel (e.g., a touch pad or a touch screen), a gyroscope, an accelerometer, a position detector, an audio input device, and/or any suitable input device that enables the player to interact with the gaming machine 12 to play a skill-based game.

The coin slot 28 includes an opening that is configured to receive coins and/or tokens deposited by the player into the gaming machine 12. The gaming machine 12 converts a value of the coins and/or tokens to a corresponding amount of gaming credits that are used by the player to wager on games played on the gaming machine 12. The bill acceptor 30 includes an input and output device that is configured to accept a bill, a ticket, and/or a cash card into the gaming machine 12 to enable an amount of gaming credits associated with a monetary value of the bills, ticket, and/or cash card to be credited to the gaming machine 12.

Referring to FIG. 2, in the illustrated embodiment, the gaming controller 18 includes a processor 44, a database 46, a memory device 48 coupled to the processor 44 and the database 46, a credit module 50, a random-number generator 52, a display module 54, a player selection module 56, and a target selection module 58. The memory device 48 includes a computer readable medium, such as, without limitation, random access memory (RAM), read-only memory (ROM), erasable programmable read-only memory (EPROM), flash memory, a hard disk drive, a solid state drive, a diskette, a flash drive, a compact disc, a digital video disc, and/or any suitable device that enables the processor 44 to store, retrieve, and/or execute instructions and/or data.

The processor 44 executes various programs, and thereby controls other components of the gaming controller 18 according to player instructions and data accepted by the user input device 16. The processor 44 in particular executes a game program, and thereby conducts a game in accordance with the embodiments described herein. The memory device 48 stores programs and databases used by the processor 44. Moreover, the memory device 48 stores and retrieves information in the database 46 including, but not limited to, a game type, a number of game symbols associated with a game, a number of player selectable game symbols, a plurality of simulated movements associated with each game symbol, a list of character symbols being associated with a skill-base game, a list of skill movements associated with character symbols, a list of wager amounts being associated with skill movements and/or character symbols, a list of skill achievements, a list of awards being associated with skill achievements, and/or image data for producing game images and/or screens on the display device 14, and temporarily stores variables, parameters, and the like that are used by the processor 44. In addition, the memory device 48 stores indicia, symbol weights, paytables, and/or winning combination tables which represent relationships between combinations of random numbers, combinations of symbol matches and types of awards. In one embodiment, the memory device 48 utilizes RAM to temporarily store programs and data necessary for the progress of the game, and EPROM to store, in advance, programs and data for controlling basic operation of the gaming machine 12, such as the booting operation thereof.

The credit module 50 manages the amount of player's credits, which is equivalent to the amount of coins and bills counted and validated by the bill acceptor 30. The credit module 50 converts a player's credits to coins, bills, or other monetary data by using the coin tray and/or for use in dispensing a credit voucher via the bill acceptor 30.

The display module 54 controls the display device 14 to display various images on screens preferably by using computer graphics and image data stored in the memory device 48. More specifically, the display module 54 controls the game symbols displayed in a primary game such as, for example, a bingo-type game 60 (shown in FIG. 4) and in secondary game such as, for example, a skill-based game 62 (shown in FIG. 5) displayed on the display device 14 by using computer graphics and the image data. In the illustrated embodiment, the skill-based game 62 includes a plurality of targets 64 being displayed within a playing field 66 and a launching device 68 for launching a player selectable item 70 towards the targets 64.

The random-number generator (RNG) 52 generates and outputs random numbers to the processor 44 preferably at the start of each round of game. In addition, the processor 44 may use random numbers generated by the RNG 52 to determine if a triggering condition has occurred in the outcome of the game, and to determine whether or not to provide an award to a player. For example, if the game is a bingo-type game, the processor 44 uses the RNG 52 to randomly select one or more bingo cards for use during the bingo-type game and to randomly select a plurality of game symbols during a symbol draw. The processor 44 compares the game symbols selected during the draw with the symbols and/or numbers displayed in the selected bingo cards to determine a number of bingo cards symbols matching the randomly selected game symbols. The processor 44 also compares the determined symbol matches with winning combinations stored in the winning combination table to determine if the symbol matches include a winning outcome that is associated with a type of award. In addition, the processor 44 may determine if a triggering condition occurred in the bingo-type game and provides an additional award such as, for example, a bonus feature game and/or an enhanced award based on the triggering condition.

The player selection module 56 includes a list including a plurality of player selectable items 70 that may be used in the skill-based game 62 and a plurality of predefined simulated movements that may be used with each of the player selectable items 70. The player selection module 56 receives a player selection input from the input device 16 and selects items 70 based on the player's selection. In addition, the player selection module 56 receives a player selection input associated with a movement of a selected item 70 and generates a simulated item movement such as, for example, and item trajectory, represented by phantom line 72, based on the player selection input. In one embodiment, the player selection module 56 includes a plurality of predefined simulated movements 72 associated with each item 70. The player selection module 56 may select a predefined simulated movement 72 associated with an item 70 based on the received player selection input and display the item 70 with the simulated movement 72.

For example, during play of a skill-based game 62, the gaming controller 18 may display a plurality of player selectable items 70 on the display device and allow the player to select one or more items 70 for use in the skill-based game 62. The gaming controller 18 displays the skill-based game 62 with the selected item 70 and allows the player to select a movement to be associated with item 70 during the skill-based game 62. The player selection module 56 receives a player selection input indicative of the player's selected movement and determines a predefined simulated movement 72 to be associated with item 70 based on the player selection input. The processor 44 determines an outcome of the skill-based game 62 based on the selected predefined simulated movement 72, and displays the skill-based game 62 including the item 70 being displayed with the selected predefined simulated movement 72. In one embodiment, the processor 44 may use the RNG 52 to randomly select one or more predefined simulated movements 72 to be displayed with the selected item 70. In addition, the processor 44 may use the RNG 52 to randomly select an item 70 for use in the skill-based game 62.

The target selection module 58 includes list including a plurality of targets 64 that are associate with each predefined simulated movement 72. In addition, the target selection module 58 also includes a plurality of paytables including a listing of awards associated with each target 64. The paytables may also include a listing of awards based on an amount of the wager received with the primary game 60, a wager received with the skill-based game 62, and/or an amount of items purchased during the skill-based game. In the illustrated embodiment, the target selection module 58 is configured to receive a predefined simulated movement 72 associated with a selected item 70 and determine whether a target 64 is contacted by the selected item 70 based on the predefined simulated movement 72. In addition, the target selection module 58 determines an award associated with a contacted target 64 based in the selected predefined simulated movement 72. For example, in one embodiment, during play of the skill-based game 62, the gaming controller 18 displays each target 64 a distance from the selected item 70. The target selection module 58 receives the selected predefined simulated movement 72 associated with the item 70 and selects a target 64 to be contacted by the item 70 based on the selected predefined simulated movement 72. The gaming controller 18 then displays the item 70 contacting the selected target 64 with the selected simulated movement 72, and provides an award to the player determined as a function of the selected target 64.

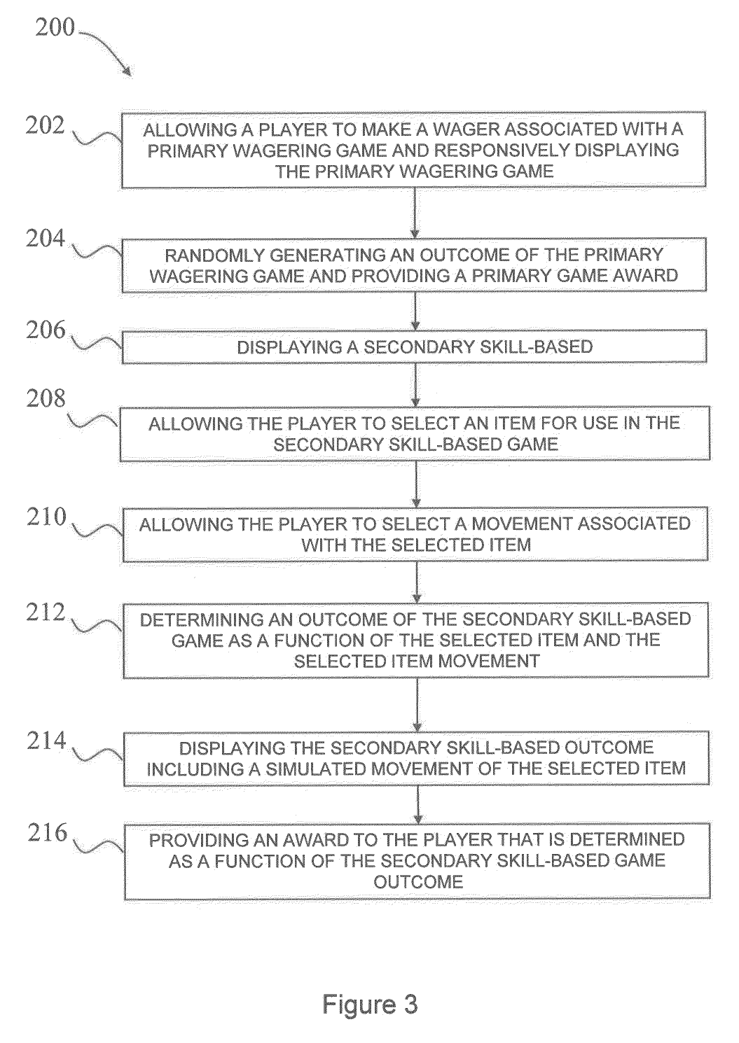

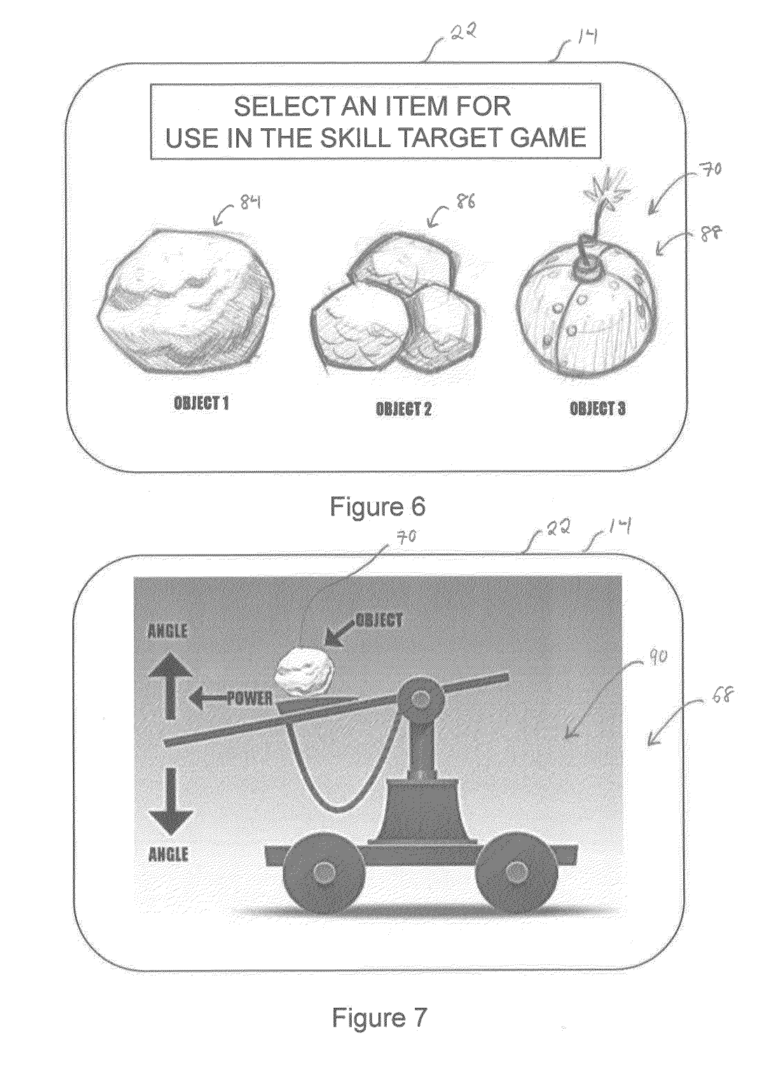

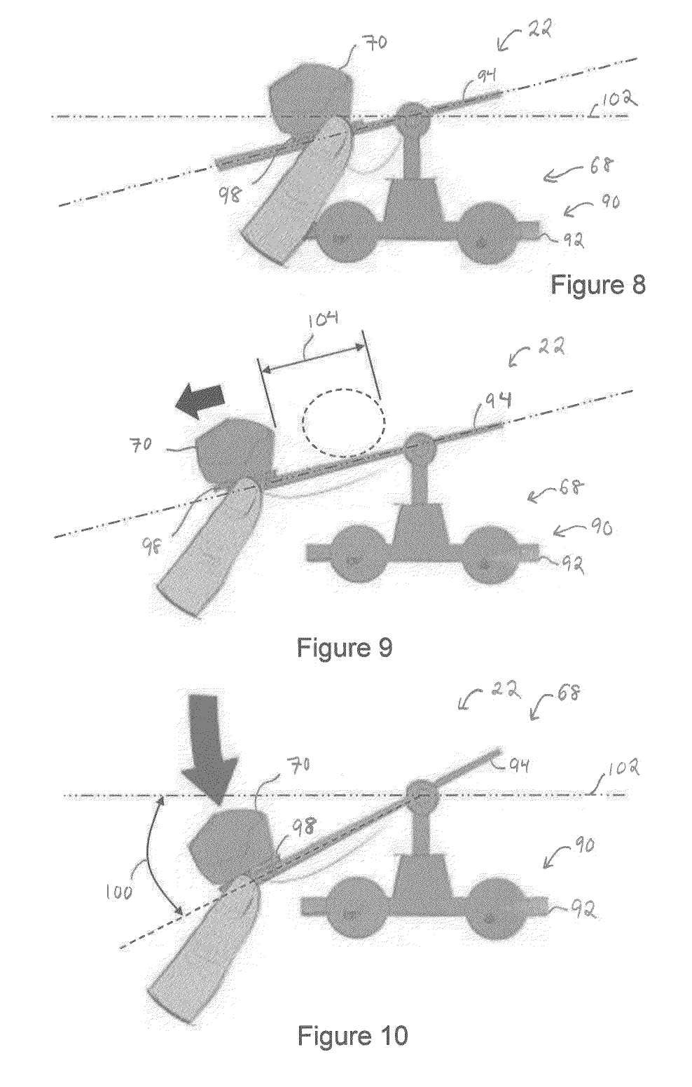

FIG. 3 is a flowchart of a method 200 that may be used with the system 10 for allowing a player to play a wagering game and a skill-based game on the gaming machine 12. The method 200 includes a plurality of steps. Each method step may be performed independently of, or in combination with, other method steps. Portions of the method 200 may be performed by any one of, or any combination of, the components of the system 10. FIG. 4 is an exemplary entertaining graphical display of the bingo-type wagering game 60 that may be played with the system 10. FIG. 5 is an exemplary entertaining graphical display of the skill-based game 62 that may be played with the system 10. FIGS. 6-11 are entertaining graphical displays that may be used with the method 200.

In the illustrated embodiment, in method step 202, the gaming controller 18 allows a player to make a wager associated with a primary wagering game 60 and responsively displays the primary wagering game 60 on the display device 14. In step 204, the gaming controller 18 randomly generates an outcome of the primary wagering game 60 and provides a primary game award to the player as a function of the primary wagering game outcome. In one embodiment, the primary wagering game 60 is the video bingo-type game 60. However, it should be noted that the wagering game 60 may be any type of game upon which a player could make a wager including, but not limited to a slot game, a blackjack game, a video poker game, or any type of game that enables the gaming machine 12 to function as described herein.

In general, during play of the primary wagering game 60, the gaming controller 18 displays the game including one or more bingo cards 74. Each bingo card 74 includes a plurality game symbols 76 selected from a predefined set of game symbols 76. In one embodiment, the plurality of game symbols 76 may include numbers. Alternatively, the plurality of game symbols 76 may include any symbol that may be selected from a predefined set of associated symbols.

In the illustrated embodiment, each bingo card 74 includes a plurality of game symbols 76 displayed in a grid 78 and arranged along a plurality of rows 80 and a plurality of columns 82. In the illustrated embodiment, the gaming controller 18 displays the game 60 including a plurality of bingo cards 74 determined as a function of the player's wager. More specifically, the gaming controller 18 receives a wager from the player and receives a player selection input indicative of a number of bingo cards to be purchased with the wager for use in the bingo-type game 60, and displays the selected number of bingo cards 74. In the illustrated embodiment, each bingo card 74 displays a total of 15 game symbols 76 displayed within the grid 78 arranged in 3 rows 80 and 5 columns 82 in a “3×5” arrangement. Alternatively, any number of symbols 76 may be displayed in any suitable grid arrangement including, for example, 20 game symbols 76 displayed in a 4×5 arrangement, 25 game symbols 76 displayed in a 5×5 arrangement, and/or any suitable number of game symbols 76 displayed in any suitable row 80 and column 82 combination to enable the gaming controller 18 to function as described herein. In addition, the grid 78 may be displayed with a plurality of shapes such as, for example, a rectangle, a square, a diamond, a circle, and/or any suitable shape that enables the gaming controller 18 to function as described herein.

Each bingo game is generally played in a conventional manner. The player makes a wager, which may be based on a predetermined denomination and a selected number of bingo cards 74 to be selected by the player and/or a selected number of game symbols 76, and initiates a symbol draw operation. During the symbol draw operation, the gaming controller 18 randomly selects a plurality of game symbols 76 from the predefined set of game symbols 76 and sequentially displays each selected game symbol 76 on the display device 14. In one embodiment, the gaming controller 18 may compare the game symbols 76 displayed on each selected bingo card 74 with each drawn game symbol 76, and identify (shown as an “X” in FIG. 4) each bingo card symbol 76 that matches the drawn game symbol 76. In another embodiment, the player may identify the matched bingo card symbol 76.

The gaming controller 18 determines an outcome of the game 60 based on the matched symbols 76 and provides an award to the player based on the matched symbols, the wager, and a predetermined paytable. For example, the gaming controller 18 may provide an award to the player based on a predefined pattern formed by the matched symbols 76 on a bingo card 74 and/or a predefined number of matched symbols 76 on one or more bingo cards 74. Moreover, the gaming controller 18 may also determine a type of game symbol that is matched and provide an award if the matched symbol types are associated with a predefined symbol type. In general, the term “award” may be a payout, in terms of credits or money. Thus, the gaming controller 18 may award a regular payout in response to the outcome of the wagering game 60. However, it should be noted that the term award may also refer to other types of awards, including, prizes, e.g., meals, show tickets, etc. . . . , as well as in-game award, such as free games, bonus symbols, and/or special game modes. Many variations to the above described general play of a bingo-type game fall within the scope of the present invention. Such bingo games are well-known in the art, and are therefore not further discussed.

In method step 206, the gaming controller 18 displays a secondary skill-based game 62 on the display device 14. In one embodiment, the gaming controller 18 determines if a triggering condition occurs in the primary game outcome and responsively displays the secondary skill-based game 62 based on the occurrence of the triggering condition. For example, in one embodiment, the gaming controller 18 may determine an amount of wagering credits accumulated by the player during a gaming session and/or during play of the primary game 60, and determine the triggering condition to occur if the amount of wagering credits is greater than, or equal to, a predefined amount of wagering credits. In another embodiment, the gaming controller 18 may define the triggering condition as a predefined amount of wagering credits placed as a wager during the primary game 60. In another embodiment, the gaming controller 18 may define the triggering condition as an appearance of a special symbol in the primary game outcome.

In the illustrated embodiment, the secondary skill-based game 62 is a target based game and includes a plurality of targets 64 and a plurality of player-selectable items 70 for use in contacting (such as impacting, knocking down, and/or destroying) the plurality of targets 64. Alternatively, the secondary skill-based game 62 may include a game that includes a player skill component associated with a player's input and that determines an outcome of the game based at least in part on the player skill component.

In the illustrated embodiment, the gaming controller 18 is configured to display the secondary skill-based game 62 including a plurality of targets 64 displayed within a playing field 66. The gaming controller 18 also displays a launching device 68 that may be used by the player to launch an item 70 from the launching device 68 towards the targets 64. Each target 64 is spaced a distance form the launching device 68 to allow the player to cause the item 70 to be moved from the launching device 68 towards the targets 64 along a item trajectory 72.

In step 208, the gaming controller 18 allows the player to select at least one item 70 from the plurality of player-selectable items 70 for use in the secondary skill-based game 62. For example, as shown in FIG. 6, the gaming controller 18 may display a plurality of player selectable items 70 and allow the player to select one or more player selectable items 70. The gaming controller 18 receives a player selection input indicative of a selected item 70 and displays the selected item 70 in the secondary skill-based game 62 for use by the player. In the illustrated embodiment, each item 70 includes a corresponding simulated movement. The simulated movement may be, for example, a trajectory 72, multiple trajectories, a change in shape, a change in direction, and/or any visual characteristic that may be associated with the item 70. For example, as shown in FIG. 6, 3 items 70 may be displayed for selection by the player, including a large boulder 84, small boulders 86, and a bomb 88, each having a different trajectory 72 when launched from the launching device 68. The bomb 88 may include an additional “exploding” characteristic when contacting a target. The small boulders 86 may also separate during flight such that multiple trajectories occur when the small boulders 86 are launched, wherein each small boulder has a different trajectory. Many variations to the above described simulated movements fall within the scope of the present invention.

In step 210, the gaming controller 18 allows the player to select a movement associated with the selected item 70. As shown in FIGS. 7-10, the gaming controller 18 is configured to display the launching device 68 to allow a player to manipulate the launching device 68 via player selection inputs (represented as a “finger” being swiped across the user input device 14) that correspond to the player skill component of the secondary skill-based game 62. In the illustrated embodiment, the launching device 68 includes a catapult 90 that launches the selected item 70 along the determined item trajectory 72 from a starting position 91 to an ending position 93. The catapult 90 is displayed including a base 92, a throwing arm 94 attached to the base 92, and a projectile support 98 for supporting the item 70 from the throwing arm 94.

In the illustrated embodiment, each player selectable item 70 is associated with a plurality of predefined trajectories 72. The player uses a skill component in selecting a trajectory 72 to be associated with the item 70 to contact the targets 64 displayed in the playing field 66. The gaming controller 18 allows the player to select a characteristic of the catapult 90 and selects a predefined trajectory 72 based on the selected catapult characteristic. In one embodiment, the catapult characteristics may include an angle of incline 100 of the throwing arm 94 and a power of the catapult 90. For example, in one embodiment, during play of the game 62, the player may adjust an angle of incline 100 of the catapult 90 by adjusting the angle of the throwing arm 94 with respect to a horizontal axis 102. In addition, the player may adjust a launch power associated with item 70 by moving the item 70 a distance 104 along the throwing arm 94. As the player adjust the angle of incline 100 and the catapult power, the gaming controller 18 determines the trajectory 72 associated with the angle 100 and power to be used when the player releases the item 70. More specifically, the player selection module 56 receives player selection input indicative of the selected item 70, the selected incline angle 100, and the selected launch power, and determines a predefined trajectory 72 to be displayed with the item 70. Once the player has adjusted the angle of incline 100 and the launch power, the player releases the item causing the catapult 90 to hurl the item towards the targets 64 along the selected trajectory 72.

In step 212, the gaming controller 18 determines an outcome of the secondary skill-based game 62 as a function of the selected item 70 and the selected item movement 72. In step 214, the gaming controller 18 displays the secondary skill-based outcome including a simulated movement of the selected item 70 in which the selected item 70 is displayed as either contacting a target 64 or not contacting a target 64. In the illustrated embodiment, the target selection module 58 selects a target 64 to be contacted by the item 70 based on the determined item trajectory 72. More specifically, the target selection module 58 receives information indicative of the determined item trajectory 72 from the player selection module 56 and determines whether a displayed target 64 is contacted by the item 70 based on the determined trajectory 72.

In step 216, the gaming controller 18 provides an award to the player that is determined as a function of the secondary skill-based game outcome. More specifically, the gaming controller 18 determines whether to provide an award to the player based on the player selection input associated with the skill-based component. For example, the gaming controller 18 may provide an award to the player if the player selects an item trajectory 72 that causes the item to contact one or more targets 64.

In one embodiment, the gaming machine 12 may provide an award based on the outcome of the skill-based game 62 that includes wagering credits that may be used to place a wager in the primary wagering game 60. For example, the target selection module 58 may include a paytable including a plurality of awards associated with a plurality of predefined item trajectories 72. The gaming controller 18 may determine the predefined item trajectory 72 based on player selection input and provide an award based on the selected item trajectory 72 and the award paytable.

In addition, the gaming controller 18 may display each target 64 with an associated wagering credit value, determine the award based on the player selection input, and display the skill-based game outcome including displaying the selected item 70 contacting a target 64 having a credit value corresponding to the determined award. For example, the gaming controller 18 may display the item 70 contacting one target 64 having a wagering credit value equal to the determined award value. In addition, the gaming controller 18 may display the item 70 contacting a plurality of target 64 each having a wagering credit value the sum of which is equal to the determined game award.

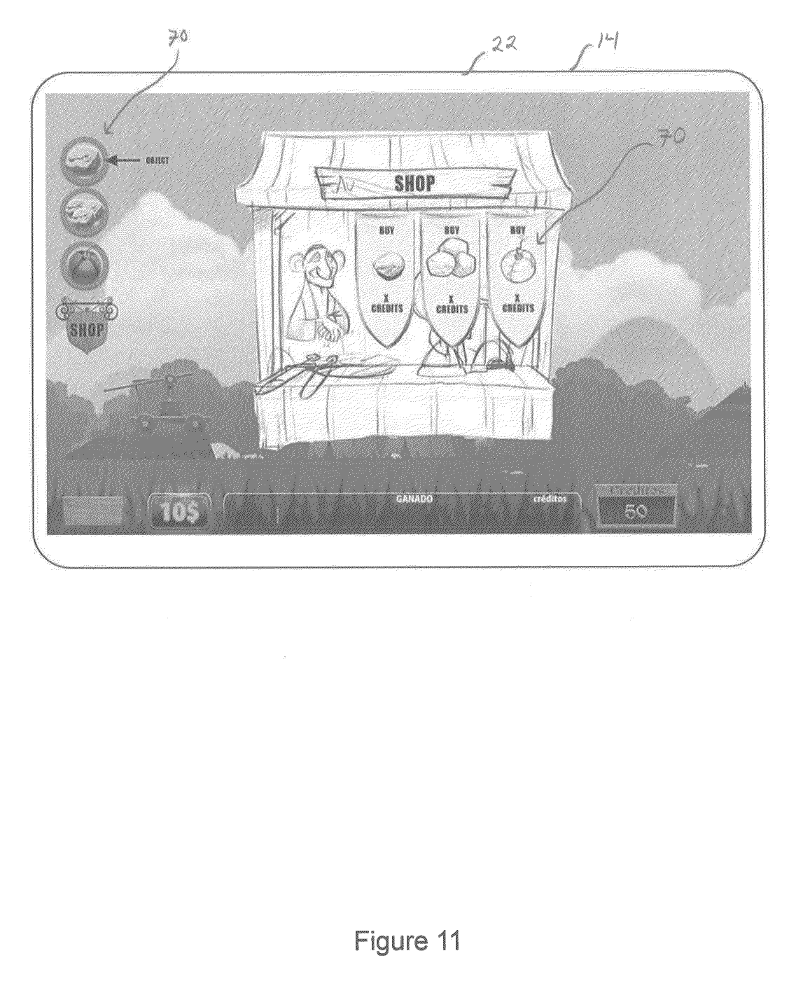

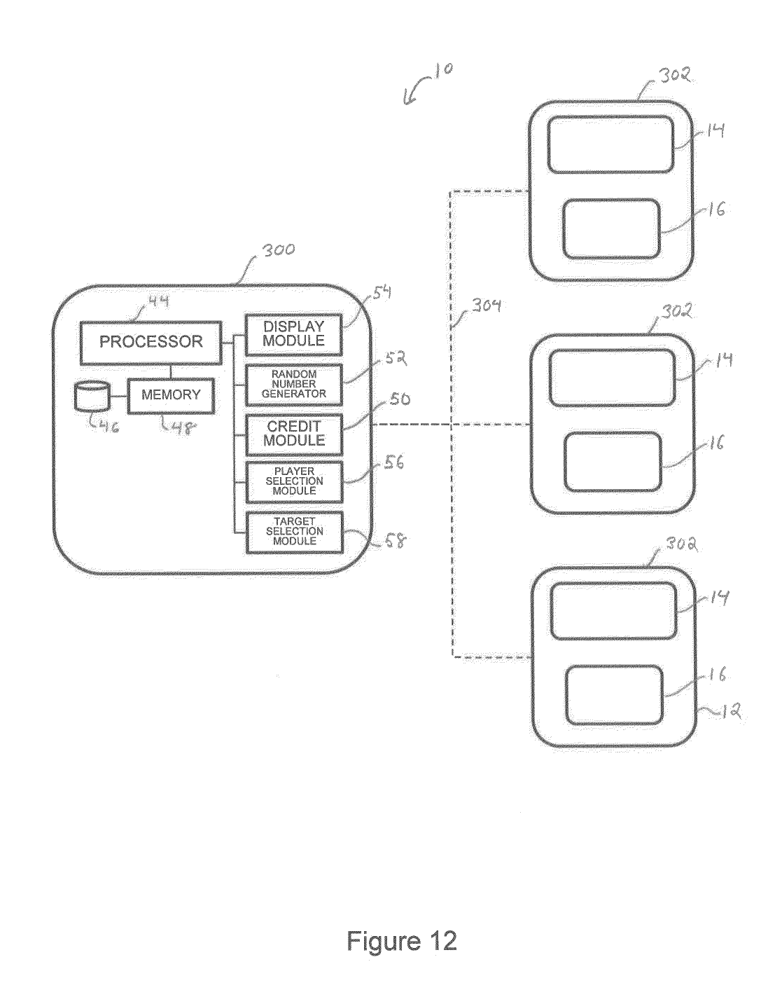

In the illustrated embodiment, the gaming controller 18 is configured to allow the player to purchase an item 70 from a plurality of player selectable items 70 and display the secondary skill-based game with the purchased item 70. For example, as shown in FIG. 11, the gaming controller 18 may display a plurality of items 70 that may be purchased by the player using wagering credits received during play of the primary game 60. The gaming controller 18 may allow the player to purchase each item 70 using gaming credits awarded during the primary game 60 and/or gaming credits stored in the credit module 50. Moreover, the gaming controller 18 may allow the player to use wager credits awarded during play of the secondary skill-based game 62 to purchase additional items 70.

In one embodiment, the gaming controller 18 displays each item having a different purchased value. The gaming controller 18 may select a paytable based on the value of the item 70 purchased by the player. In addition, the gaming controller 18 may determine a number of targets 64 and/or a value of targets 64 being displayed in the secondary skill-based game 62 based on the value of the purchased item 70. For example, in one embodiment, the gaming controller 18 may select a paytable having a higher value of awards associated with each target 64 when the player purchases a higher value item 70. In addition, the gaming controller 18 may display a greater number of higher value targets 64 when the player purchases a higher value item 70, and display a greater number of lower value targets 64 when the player purchases a lower value item 70. The gaming controller 18 may also provide a predefined number of free items 70 that maybe used by the player during the skill-based game 62, and prompt the player to purchase additional items 70 when the player has played each free item 70.

In the illustrated, the gaming controller 18 tracks a period of time elapsed from the display of the secondary skill-based game 62 and receiving a player selection input to initiate play of the skill-based game 62. In one embodiment, the gaming controller 18 randomly selects an item for use in the secondary skill-based game 62 if the player does not select an item 70 within a predefined period of time. More specifically, the gaming controller 18 selects an item 70 if a player selection input indicative of a player's selection of an item is not received within an elapsed predefined period of time since the display of the secondary skill-based game. In another embodiment, the gaming controller 18 may randomly select a simulated movement associated with the selected item 70 if a player selection input indicative of a player's selection of the item movement is not received within an elapsed predefined period of time since the selection of the item 70.

In another embodiment, the gaming controller 18 is configured to allow a player to make a wager associated with the skill-based game 62 and provide an award determined as a function of secondary skill-based game outcome, the player's wager, and a predetermined paytable. In one embodiment, the gaming controller may allow the player to purchase at least one item from the plurality of player-selectable items using the wager and allow the player to select a movement associated with the selected item 70. The gaming controller 18 may also determine an outcome of the skill-based game as a function of the purchased item 70 and the selected item movement, and provide an award to the player as a function of the skill-based game outcome, the wager, and a paytable.

FIG. 5 is a schematic view of an exemplary gaming system 10. The gaming system 10 includes a system controller 300 and one or more gaming terminals 302 that are coupled to the system controller 300. In one embodiment, the gaming terminal 302 includes the gaming machine 12. In another embodiment, gaming terminal 302 may include a personal computer, laptop, cell phone, smartphone, tablet computer, personal data assistant, and/or any suitable computing device that enables a player to connect to system controller 300 to play the games 60 and 62.

In the illustrated embodiment, the gaming machines 12 and the system controller 300 are coupled in communication with a local area network (LAN) 304. Alternatively, the gaming machines 12 and the system controller 300 may be coupled via a network such as, for example, an Internet link, an intranet, a WAN, dial-in-connections, cable modems, wireless modems, and/or ISDN lines. In one embodiment, the system controller 300 may be implemented by one of the gaming controllers 18 associated with a gaming machine 12. In the illustrated embodiment, the system controller 300 includes a processor 44, a database 46, a memory device 48 coupled to the processor 44 and the database 46, a credit module 50, a random-number generator 52, a display module 54, a player selection module 56, and a target selection module 58. The system controller 300 is configured to perform all of the functions of the gaming controller 18 as described herein.

In the illustrated embodiment, the system controller 300 includes multiple instances of the games 60 and 62 such that each gaming terminal 302 may play a separate instance of the games 60 and 62 simultaneously. Alternatively, the system controller 300 enables players on one or more gaming terminals 302 to simultaneously play the same game.

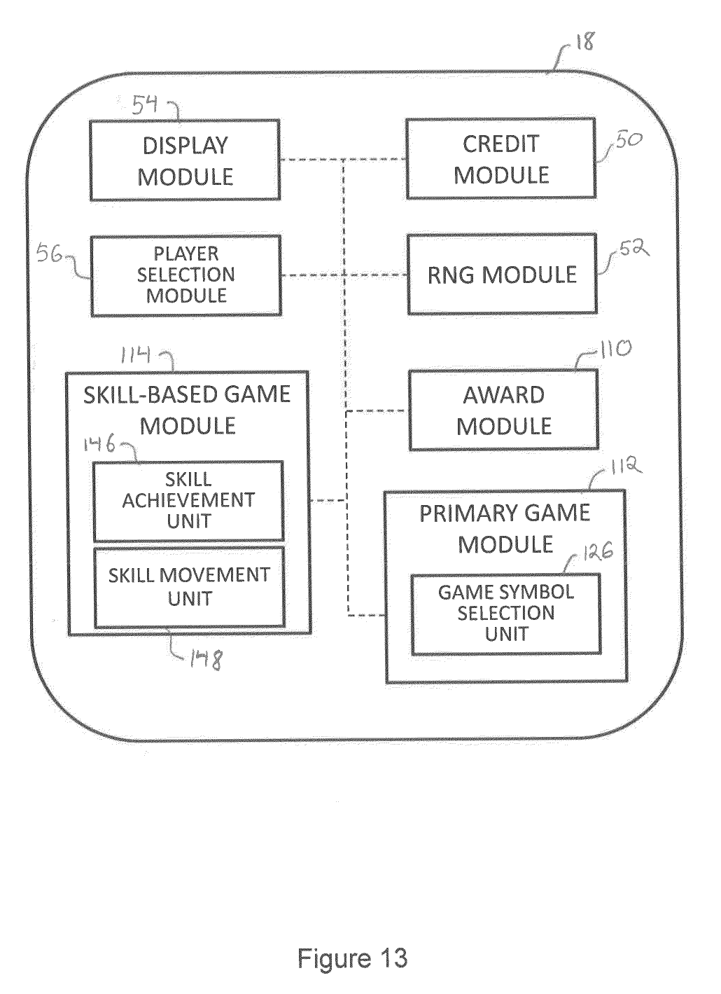

FIG. 13 is another schematic view of the gaming controller 18. In the illustrated embodiment, the gaming controller 18 includes the display module 54, the random-number generator (RNG) module 52, the credit module 50, the player selection module 56, an award module 110, a primary game module 112, and a skill-based game module 114.

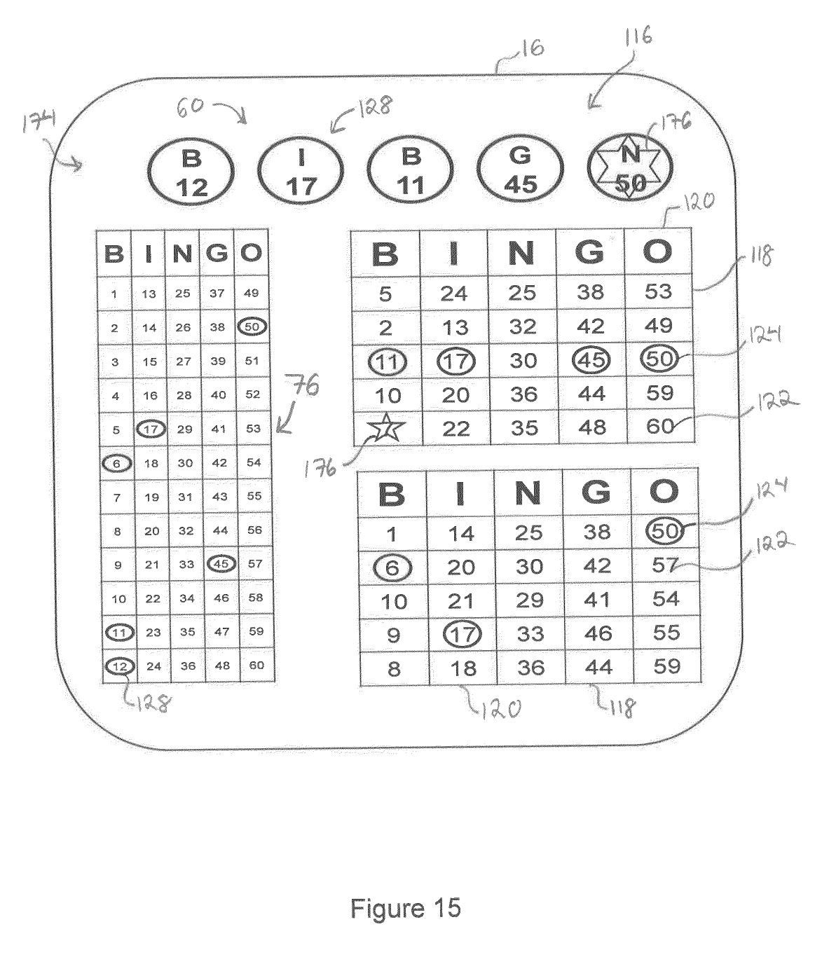

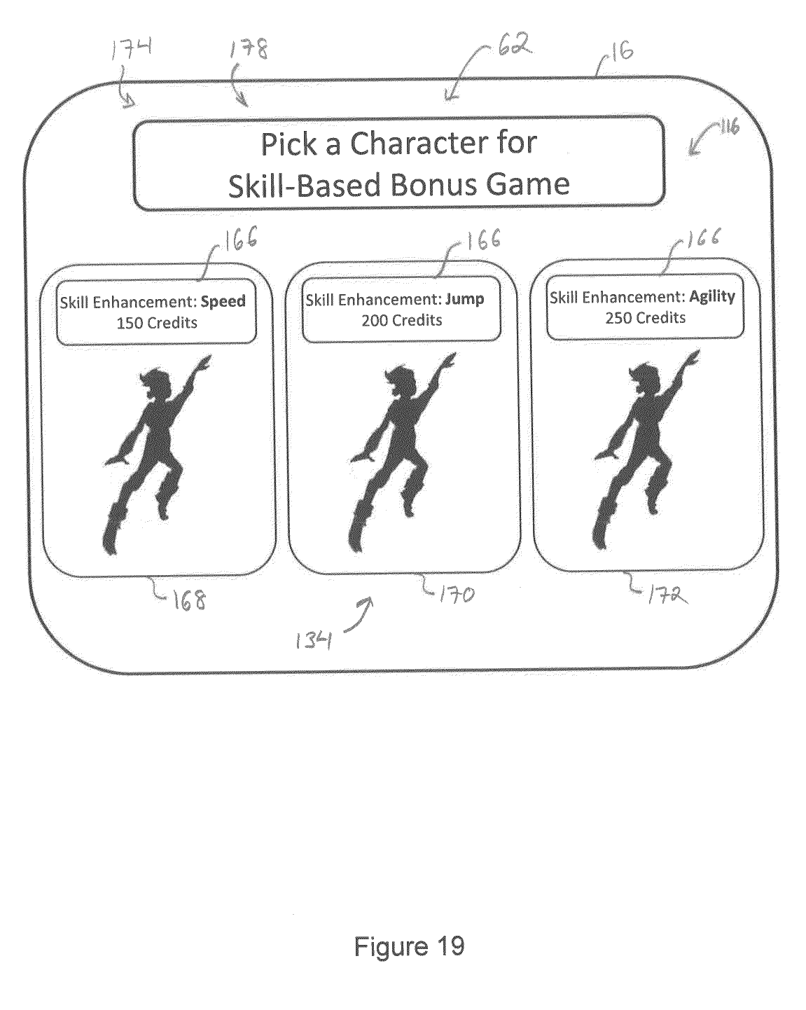

The display module 54 controls the display device 14 to display various images on a graphical interface 116 preferably by using computer graphics and image data. More specifically, the display module 54 controls the game symbols displayed in a primary game such as, for example, a bingo-type game 60 (shown in FIGS. 4 and 13) and in secondary game such as, for example, a skill-based game 62 (shown in FIG. 5 and FIGS. 16-19), being displayed on the display device 14 by using computer graphics and the image data. In the illustrated embodiment, the display module 54 also displays a plurality of user selection areas 118 (shown in FIGS. 15 and 19) within the graphical interface 116 that correspond to specific operations that may be initiated by the user. For example, in the illustrated embodiment, the display module 54 displays each game symbol including and associated selection area 118 to enable the user to select each displayed game symbol to indicate a user's selection of the corresponding game symbol. Each of the selection areas 118 may receive a user selection input via the user input device 16.

The credit module 50 communicates with the bill acceptor 30 and the coin slot 28 to manage the amount of player's credits available for use in playing the primary game 60 and the secondary game 62. The credit module 50 manages the amount of player's credits, which is equivalent to the amount of coins and bills counted and validated by the bill acceptor 30. The credit module 50 converts a player's credits to coins, bills, or other monetary data and dispensed the coins to the player using the coin tray 32. In addition, the credit module 50 may dispense a credit voucher via the bill acceptor 30. The credit module 50 may display a credit meter (not shown) on the display device 14 including an amount of gaming credits available to the player for use in playing the primary and secondary games. During a gaming session, the credit module 50 may deduct an amount of credits equal to the amount of wagers made by the player from the credit meter, and credit any awards provided to the player based on the outcome of the games to the credit meter. The credit module 50 receives a user selection indicative of a request from the player to play a game including an amount of game credits associated with the selected game. The credit module 50 determines if sufficient game credits are available in the corresponding credit meter and deducts a corresponding amount of game credits from a corresponding credit meter. If the credit module 50 determines that the credit meter does not include a sufficient amount of game credits, the credit module 50 may display a message to the player requesting the player to provide additional funds to purchase additional game credits corresponding to the request.

The primary game module 112 includes a wagering game program for use in playing a wagering game based on players selections received from the user input device 16. The primary game module 112 retrieves game elements from the database 46, and causes the display module 54 to display the game on the display device 14. The primary game module 112 receives signals indicative of the player input, generates an outcome of the game based on the predetermined game rules and the received player selections, and displays the game outcome on the display device 14.

The RNG module 52 generates and outputs random numbers to the primary game module 112 for use in playing the primary game 60 and the secondary game 62. In addition, the primary game module 112 may use random numbers generated by the RNG module 52 to determine if a winning condition has occurred in the outcome of the primary game 60, and to determine whether or not to provide an award to a player. For example, if the primary game 60 is the bingo-type game 60, the primary game module 112 uses the RNG module 52 to randomly select one or more bingo cards 120 (shown in FIG. 15) including a plurality of bingo symbols 122 and/or bingo numbers for use during the bingo-type game 60. The bingo symbols 122 are selected from a predefined set of game symbols 76. In addition, the primary game module 112 uses the RNG module 52 to randomly select a plurality of game symbols 76 during a symbol draw operation. The primary game module 112 compares the game symbols 76 selected during the draw operation with the bingo symbols 122 and/or numbers displayed in the selected bingo cards 120 to determine a number of bingo symbols 122 and/or numbers matching the randomly selected game symbols 76.

In the illustrated embodiment, the player selection module 56 allows a player to mark or “daub” a matching bingo symbol 122 during play of the bingo-type game 60. Moreover, the player selection module 56 may receive a player's selection from the user input device 16, select the bingo symbols 122 based on the player's selection, and display a notification, represented as a circle 124, indicative of the player's selection on the graphical interface 116 to indicate the daubed symbol. In one embodiment, the player selection module 56 may automatically daub matching bingo symbols 122 during the symbol draw operation, and display the daubed bingo symbols 122 on the corresponding bingo card 120.

In the illustrated embodiment, the primary game module 112 includes a game symbol selection unit 126. The game symbol selection unit 126 is configured to randomly select drawn symbols 128 from a predefined set of game symbols 76 for use in the bingo-type game 60. For example, in one embodiment, the game symbol selection unit 126 may conduct a symbol draw operation including randomly selecting a plurality of drawn symbols 128 from the predefined set of game symbols 76 for use in the bingo-type game 60 and determine if each randomly selected drawn symbol 128 matches one or more bingo symbols 122 associated with the selected bingo cards 120.

The primary game module 112 determines an outcome of the bingo-type game 60 including any determined symbol matches and transmits the game outcome to the award module 110. The award module 110 compares the game outcome with winning combinations stored in a winning combination table to determine if the symbol matches include a winning outcome that is associated with a type of award. In general, the term “award” may be a payout, in terms of credits or money. However, it should be noted that the term award may also refer to other types of awards, including, prizes, e.g., meals, show tickets, etc. . . . , as well as in-game award, such as free games. In one embodiment, the award module 110 may determine if a triggering condition occurred in the bingo-type game 60 and provide an additional award such as, for example, a bonus feature game and/or an enhanced award based on the triggering condition.

The skill-based game module 114 includes a skill game program for use in playing a skill-based game 62 based on players selections received from the user input device 16. The skill-based game module 114 retrieves game elements from the database 46, and causes the display module 54 to display the skill-based game 62 on the display device 14 with the retrieved game elements. The skill-based game module 114 receives signals indicative of the player input, generates an outcome of the skill-based game 62 based on the predetermined game rules and the received player selections, and displays the game outcome on the display device 14.

Referring to FIGS. 16-19, in the illustrated embodiment, the skill-based game module 114 displays a skill-based game 62 that includes a plurality of awards that are associated with a plurality of skill achievements. The player receives an award by obtaining one or more corresponding skill achievements being associated with the corresponding award. In one embodiment, the skill-based game module 114 receives a skill input from the player via the user input device 16, determines if the player obtains the skill achievement as a function of the received skill input, and responsively provides the corresponding award to the player as a function of the obtained skill achievement. In one embodiment, the skill input may include, but is not limited to, an input received from a player via the user interface corresponding to a timing, a predefined time period, a predefined duration, a direction of movement, a pattern of movement, and/or any suitable input received via the user interface that may be associated with a skill of a player such as, for example a physical or manual dexterity, digital dexterity, and/or hand-eye coordination.

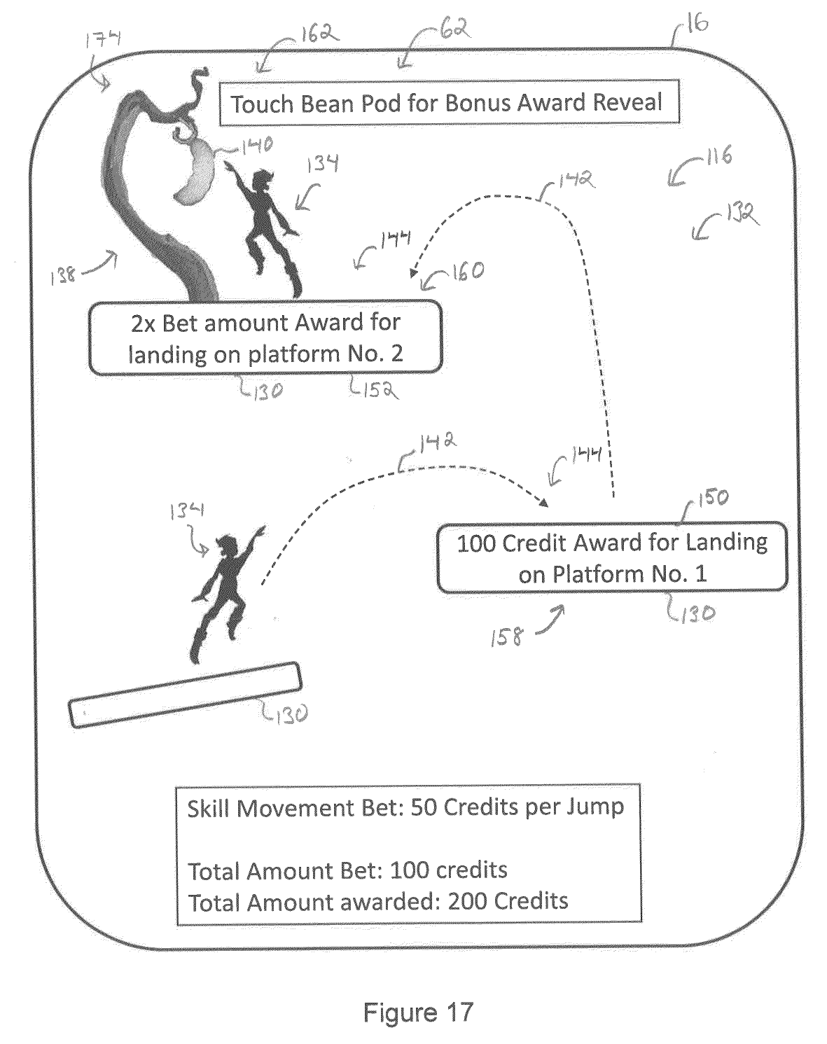

The skill-based game module 114 displays the skill-based game 62 including a plurality of platforms 130 being displayed within a playing field 132, and a character symbol 134 that is movable through the playing field 132. In one embodiment, the skill-based game 62 may be displayed with a “Jack and the Beanstalk” game theme (shown in FIGS. 16 and 17) that allows the character symbol 134 to move to each platform 130, avoid obstacles 136, and/or gather bonus symbols 138 such as, for example bean pods 140, to achieve a variety of awards. In one embodiment, the skill-based game module 114 displays the skill-based game 62 including a character symbol 134 that is controllable by the player via a plurality of skill inputs corresponding to player's selection received via the user input device 16. The character symbol 134 is adapted to perform a plurality of skill movements, represented by line 142, in response to a received skill input. For example, in one embodiment, the character symbol 134 is movable through the playing field 132 and is able to obtain a plurality of skill achievements 144 being positioned within the playing field 132 by performing a corresponding skill movement 142. Each skill achievement 144 is associated with a corresponding award.

In the illustrated embodiment, the skill-based game module 114 includes a skill achievement unit 146 and a skill movement unit 148. The skill achievement unit 146 is configured to select a plurality of skill achievements from a list of skill achievements stored in the database 46 and display the selected skill achievements 144 on the playing field. In addition, the skill achievement unit 146 may assign one or more awards such as, for example an amount of credits and/or a credit multiplier, to each of the skill achievements 144 being displayed in the skill-based game 62. The skill achievement 144 may include, but is not limited to, safely landing the character symbol 134 on a platform 130 (as shown in FIG. 17), avoiding an obstacle 136 being displayed in the playing field 132 (shown in 18), and/or any suitable skill achievement that may require a skill movement to be initiated by a player.

The skill movement unit 148 assigns one or more skill movements 142 to a skill achievement 144 such that a character symbol 134 must perform the assigned skill movements in order to obtain the skill achievement 144. In addition, the skill movement unit 148 may also received a skill input from a player via the user input device 16, match the received skill input with an associated skill movement being stored in the database 46, and cause the character symbol 134 to perform the associated skill movement 142. During game play, when the player attempts to obtain a skill achievement 144, the skill movement unit 148 will receive a skill input from the player and determine the skill movement 142 being associated with the received skill input. The skill movement unit 148 may also determine if the selected skill movement 142 matches the skill movement associated with the corresponding skill achievement 144. If the skill movements 142 match, the skill movement unit 148 will display the character symbol 134 performing the requested skill movement 142 and obtaining the skill achievement 144, e.g. safely landing on a platform 130. If the player selected skill movement 142 does not match the required skill movement 142, the skill movement unit 148 may display the character symbol 134 performing the selected skill movement 142 and not obtaining the skill achievement 144, e.g. jumping towards the platform and missing the platform 130.

For example, in one embodiment, the skill movement unit 148 may determine a current location of the character symbol 134 within the playing field 132 and identify an active skill achievement 144 as a function of the character location such as, for example identifying the platform located closest to the character symbol 134. The skill movement unit 148 may also determine a first skill movement being required to obtain the active skill achievement 144. For example, the skill movement unit 148 may determine the type of jump required to land on the platform, the length of the jump, the amount of speed needed to perform the jump, the distance from the platform needed to initiate the jump, and/or the height of the jump. The skill movement unit 148 may also determine a second skill movement being associated with the skill input received from the player and allow the player to obtain the active skill achievement if the second skill movement matches the first skill movement. In addition, the skill movement unit 148 may end the skill-based game 62 if the second skill movement does not match the first skill movement, and responsively display the primary wagering game 60 including any credits awarded to the player during play of the skill-based game 62.

In the illustrated embodiment, the skill-based game module 114 may assign a corresponding bet amount and/or wager amount to each skill movement being performed by the character symbol 134. For example, the skill-based game module 114 may require the player to place a bet associated with a skill input before allowing the player to move the character symbol 134 via the skill input to perform the skill movement 142 and to obtain a skill achievement 144. In one embodiment, as shown in FIG. 17, the skill movement 142 may include a jump onto a platform 130. The skill-based game module 114 may assign a bet amount such as, for example, a 50 credit bet for each attempted jump, and require the player to place the corresponding bet before initiating the skill movement associate with the bet. For example, each time the player desires to cause the character symbol to jump from each platform 130, the skill-based game module 114 may require the player to place a corresponding bet amount. Moreover, in one embodiment, the skill-based game module 114 may assign the bet amount to a skill input, and may automatically deduct the bet amount from the player's credit meter each time the player initiates a skill input via the user input device 16.

In another embodiment, the skill-based game module 114 may provide the player a number of skill movements for use during the skill-based game 62 in response to receiving a single bet amount from the player. For example, the player may place a single bet associated with the skill-based game 62 and the skill-based game module 114 may responsively provide the player with 10 skill movements, e.g. 10 jumps, for use in moving the character symbols 134 to each platform 130 to obtain the skill achievements being associated with each platform 130. In addition, in one embodiment, the skill-based game module 114 may provide an amount of game time associated with the skill-based game 62 determined as a function of a bet amount received from the player, and allow the player to play the skill-based game 62 for a period of time equal to the amount of game time associated with the bet amount. For example, the player may place a bet associated with the skill-based game 62 and the skill-based game module 114 may responsively provide the player a predefined period of time such as, for example, a number of minutes and/or seconds, associated with the bet amount in which the player is allowed to play the skill-based game 62 to obtain skill achievements. The skill-based game module 114 may also determine an amount of skill achievements 144 obtained by the player during the predefined period of time and provide an award to the player as a function of the number of obtained skill achievements.

In the illustrated embodiment, each platform 130 is indicative of a skill achievement 144 being displayed in the skill-based game 62. More specifically, a player obtains a corresponding skill achievement 144 by moving the character symbol 134 onto a corresponding platform 130. For example, as shown in FIG. 17, in one embodiment the skill-based game 62 may be displayed with a first platform 150 and a second platform 152 that is spaced a distance from the first platform 150. The player obtains an associated skill achievement by moving the character symbol 134 from the first platform 150 to the second platform 152. During game play, the skill-based game module 114 receives a skill input from the player via the user input device 16 and causes the character symbol 134 to perform a skill movement corresponding to the received skill input. The player causes the character symbol 134 to jump from the first platform 150 and land on the second platform 152 to obtain the skill achievement 144 associated with landing on the second platform 152.

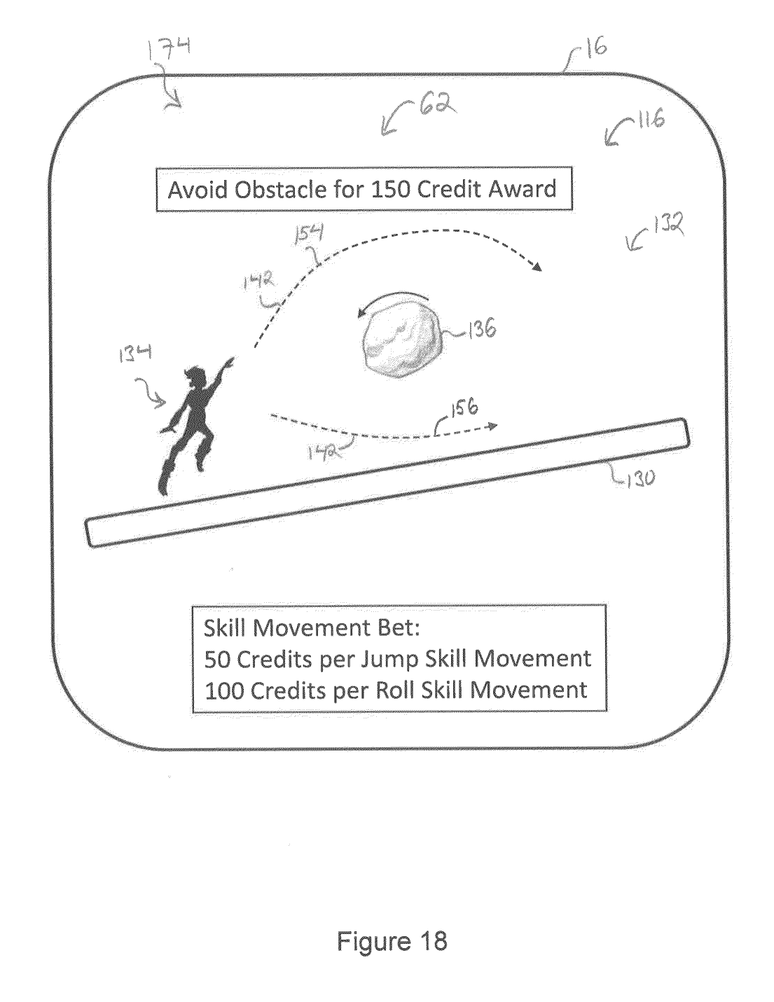

The skill-based game module 114 may also assign one or more skill movements to a corresponding skill achievement, and assign a different bet amount to each skill movement 142. For example, as shown in FIG. 18, in one embodiment, the skill achievement 144 may include avoiding an obstacle 136 such as, for example, a boulder, rock, and/or object moving towards the character symbol 134. The skill-based game module 114 may assign a first skill movement 154, e.g. a jumping action, to the skill achievement 144, assign a second skill movement 156, e.g. a rolling action to the skill achievement 144, and allow the player to select either the first skill movement 154 or the second skill movement 156 to obtain the skill achievement 144, e.g. jumping over the object or rolling under the object. In addition, the skill-based game module 114 may also assign a different bet value to each of the first and second skill movements 154 and 156 as a function of the difficulty in performing the corresponding skill movement and/or the probability of obtaining the skill achievement using the corresponding skill movement. For example, in one embodiment, the skill-based game module 114 may assign a first bet value, e.g. 50 credits, to the first skill movement 154 (jumping) and assign a second bet value, e.g. 100 credits, to the second skill movement 156 (rolling).

In one embodiment, the skill-based game module 114 assigns an award to each of the skill achievements 144 being display in the skill-based game 62. For example, in one embodiment, the skill-based game 62 may include a first skill achievement 158 having an associated award equal to an amount of wagering credits for use in the primary wagering game 60. In addition, the skill-based game 62 may also include a second skill achievement 160 having a corresponding multiplier award. Upon obtaining the first skill achievement 158 via a skill movement performed by the character symbol 134, the skill-based game module 114 provides the player with an amount of wagering credits, e.g. 100 credits for use in placing bets associated with the primary wagering game 60. Moreover, if the player obtains the second skill achievement 160, the skill-based game module 114 provides the player a credit multiplier, e.g a 2× bet multiplier, and provides an award equal to 2× the bet associated with the corresponding skill movement 142. Each award may include, but is not limited to including, an amount of wagering credits, a wagering credit multiplier, an amount of free primary wagering games, and/or any type of award that may be provided to the player as a function of obtaining a corresponding skill achievement.

In addition, the skill-based game module 114 may also display an additional bonus game 162 within the skill-based game 62. The bonus game 162 includes one or more bonus symbols 138 being displayed in the playing field 132. Each bonus symbol 138 may be associated with one or more bonus awards that may be provided to the player. During game play, the player may move the character symbol 134 to contact and/or gather a bonus symbol 138 to obtain one or more bonus awards. The skill-based game module 114 determines if the character 134 contacts, gathers, and/or selects the bonus symbol 138 and responsively provides the player a bonus award as a function of the selected bonus symbol 138. In one embodiment, the selected bonus award may be associated with a plurality of bonus awards. Upon determining the character symbol 134 has contacted the bonus symbol 138, the skill-based game module 114 retrieves a random number from the RNG for use in randomly selecting a bonus award from the plurality of bonus awards, and providing the selected bonus award to the player. For example, as shown in FIGS. 16 and 17, in one embodiment, the skill-based game module 114 may display a bonus symbol 138 with a bean pod. When the character symbol 134 touches the bean pod 140, the skill-based game module 114 randomly selects an amount of wagering credits to provide to the player as a bonus award. In one embodiment, the amount of the bonus award is determined as a function of the bet amount associated with the skill movement used to touch the bean pod 140. In addition, the bonus award may be determined as a function of the amount of skill achievements obtained prior to contracting the bean pod 140 and/or the cumulative amount of bets associated with each skill movement used during the skill-based game 62 prior to contacting the bonus symbol 138.

In one embodiment, skill-based game module 114 may display the bean pod 140 having a plurality of beans 164 contained therein. Each bean 164 may be associated with a bonus award such as, for example, an amount of wagering credits and/or a credit multiplier. In addition, each bean 164 may be associated with a different bonus award, e.g. a different amount of wagering credits. Upon contacting the bean pod 140 with the character symbol 134, the skill-based game module 114 may determine the bonus award being provided to the player as a function of each award associated with the beans 164 being contained in the bean pod 140. In one embodiment, the skill-based game module 114 may randomly determine a number of beans 164 being included in the bean pod 140 and/or randomly assign a bonus award to each bean 164 in response to the character symbol 134 contacting the bean pod 140. In addition, the skill-based game module 114 may select a plurality of bean pods 140 from a list of bean pods 140 being included in the database 46, with each bean pod 140 being associated with a different bonus award, and randomly position each bean pod 140 throughout the playing field. In one embodiment, the skill-based game module 114 may randomly place the bean pods 140 for each instance of the skill-based game 62 that is triggered from the primary wagering game 60. In addition, the skill-based game module 114 may randomly position each bean pod 140 after a predefined number of skill-based games 62 have been played.

In one embodiment, the skill-based game module 114 may display a plurality of character symbols 134 being stored in the database 46 and allow the player to select one or more character symbols 134 for use in the skill-based game 62. In addition, the skill-based game module 114 may assign one or more skill enhancements 166 to each of the characters 134 and assign a different wager amount to each corresponding skill enhancement 166. For example, in one embodiment, the skill-based game module 114 may display a first character 168 having an enhanced speed skill, a second character 170 having an enhanced jumping skill, and a third character 172 having an enhanced agility skill. The skill-based game module 114 may also allow the player to select one or more of the player selectable characters 134 and deduct a wager equal to the wager amount associated with the selected character 134 from the corresponding player's credit meter.

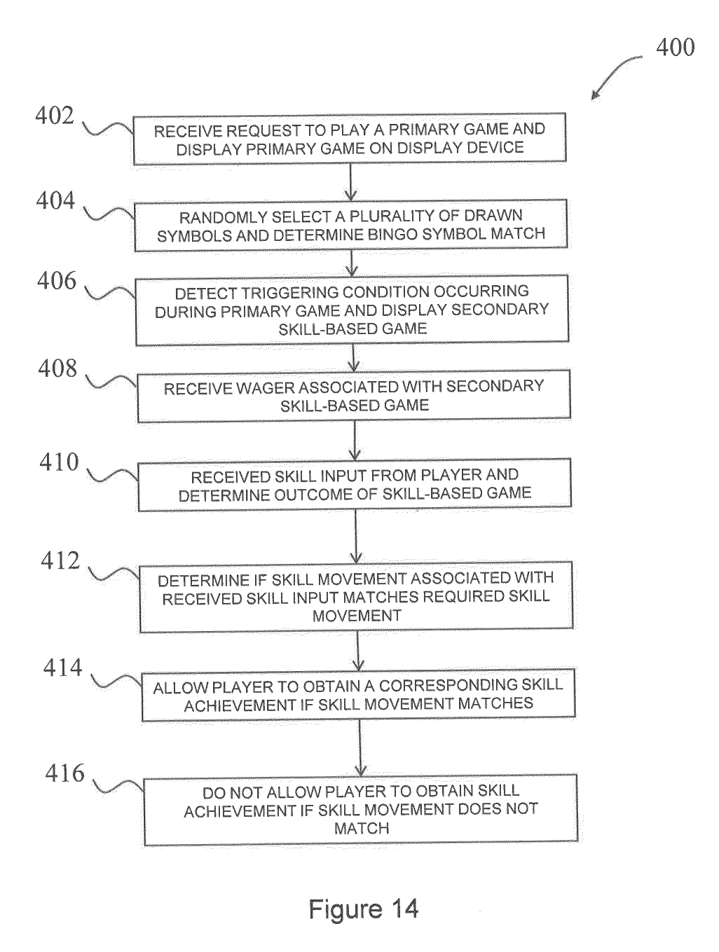

FIG. 14 is a flowchart of a method 400 that may be used with the gaming machine 10 for allowing a player to play a bingo-type game including a secondary skill-based game 62 via the gaming machine 10. Each method step may be performed independently of, or in combination with, other method steps. Portions of the method 400 may be performed by any one of, or any combination of, the components of the gaming machine 10. FIGS. 15-19 are exemplary entertaining graphical displays of the bingo-type game 60 including the secondary skill-based game 62 that may be played with the gaming machine 10. In the illustrated embodiment, entertaining graphical displays for amusement purposes are presented by the display device 14 (shown in FIG. 1) and may receive input (e.g., selections and/or entries) via the user input device 16 (shown in FIG. 1).

In the illustrated embodiment, in the method step 402, the gaming controller 18 receives a request from a player to play the primary game 60 and responsively displays the primary game 60 on the display device 14. In one embodiment, method step 402 may also include receiving a wager from the player and/or receiving a request to purchase a play of the game with game credits from a corresponding credit meter and/or player tracking account.

In method step 402, the gaming controller 18 displays a game screen 174 including a game in response to the request received from the player. In the illustrated embodiment, the gaming controller 18 displays the bingo-type game 60 within the game screen 174. However, it should be noted that the gaming controller 18 may display any type of primary game upon which a player could make a wager and/or purchase a game play including, but not limited to a slot game, a blackjack game, a video poker game, or any type of game that enables the gaming machine 10 to function as described herein.

In general, during method step 402, the gaming controller 18 displays the bingo-type game 60 including one or more bingo cards 120. Each of the bingo cards 120 includes a plurality of bingo symbols 122 that are selected from a predefined set of game symbols 76. In one embodiment, the gaming controller 18 may select one or more bingo cards 120 for use in the bingo-type game 60 as a function of the wager received from the player. In one embodiment, for example, the gaming controller 18 may allow the player to purchase one of more bingo cards 120 for use in the primary game 60.

In method step 404, the gaming controller 18 randomly selects a plurality of drawn symbols 128 from the predefined set of game symbols 76. In method step 404, the gaming controller 18 determines if each one of the plurality of drawn symbols 128 matches a corresponding one of the plurality of bingo symbols 122 being displayed in the bingo cards 120 and determines an outcome of the bingo-type game 60 as a function of the matched bingo symbols 122. For example, in method step 404, the primary game module 112 conducts a symbol draw operation, determines, for each bingo card 120, if each one of the plurality of drawn symbols 128 matches a corresponding one of the plurality of bingo symbols 122, and determines a combination formed by each of the matched bingo symbols 122. The primary game module 112 may also determine, for each bingo card 120, if the formed combination is a winning combination and responsively provide a corresponding award to the player.

In method step 406, the gaming controller 18 detects a triggering condition occurring in the primary game 60 and responsively displays the secondary skill-based game 62 on the display device 14. In one embodiment, the triggering condition may be defined as a predefined number of drawn symbols 128 being selected during the symbol draw operation. For example, the gaming controller 18 may conduct the symbol draw operation including selecting a number of drawn symbols 128, determine if the number of selected drawn symbols 128 is equal to or greater than a predefined number of drawn symbols 128, and responsively display the secondary skill-based game 62.

The triggering condition may also be defined as one or more drawn symbols 128 being matched with one or more predefined bingo symbols 122 being displayed with one or more bingo cards 120. For example, in one embodiment, one or more bingo cards 120 may include one or more special symbols 176 being associated with a bingo symbol 122. The gaming controller 18 may detect the triggering condition if a drawn symbol 128 matches the corresponding bingo symbol 122 and responsively display the secondary skill-based game 62. In addition, gaming controller 18 may detect the triggering condition if one or more special drawn symbols 128 are selected during the symbol draw operation.

In one embodiment, the triggering condition may include a predefined combination of matched bingo symbols 122. For example, during play of the primary game 60, the gaming controller 18 may identify a pattern being formed by a combination of matched bingo symbols 122, determine if the formed pattern matches a predefined triggering pattern, and responsively display and/or initiate the secondary skill-based game 62 upon detecting the triggering pattern.

In the illustrated embodiment, the gaming controller 18 display the secondary skill-based game 62 including a playing field 132, a plurality of skill achievements 144 being displayed within the playing field 132, a character 134 being displaying within the playing field 132 and being movable by the player through the playing field to obtain one or more skill achievements 144. The gaming controller 18 moves the character 134 through the playing field 132 using one or more skill movements associated with skill inputs received from the player via the user input device 16. In one embodiment, a skill achievement 144 may be associated with a platform 130 and include the character 134 successfully landing on a platform 130. In addition, the skill achievement 144 may be associated with an obstacle 136 and include the character 134 successfully avoiding an obstacle 136. In the illustrated embodiment, the gaming controller 18 displays each skill achievement including an award, and provides an award to the player as a function of each skill achievement obtained by the player during play of the skill-based game 62.

In method step 408, the gaming controller 18 receives a wager being associated with the secondary skill-based game 62 and allows the player to move the character 134 in response to receiving the wager. For example, in one embodiment, the gaming controller 18 allows the player to move the character 134 to perform a skill movement 142 to obtain a skill achievement 144 in response to receiving a wager. In addition the gaming controller 18 may require a wager for each skill movement being preformed by the character 134 in an effort to obtain one or more skill achievements 144. The gaming controller 18 may also allow the player to perform a number of character skill movements as a function of the amount of the received wager.

In addition, upon initiating the secondary skill-based game 62, the gaming controller 18 may display a character selection screen 178 that includes a plurality of characters 134 for use in the skill-based game 62. The gaming controller 18 may display each character 134 with a different skill enhancement. The gaming controller 18 may allow the player to select one or more characters 134 from the displayed characters 134 for use in the skill-based game 62. In addition, the gaming controller 18 may assign a bet amount to each of the characters 134, and allow the player to select a character 134 upon receiving a corresponding bet amount from the player.

In method step 410, the gaming controller 18 receives a skill input from the player being associated with a character skill movement and determines if the player obtains the skill achievement as a function of the skill input. In method step 412, the gaming controller 18 determines an initiated skill movement being associated with the received skill input, determines a required skill movement for obtaining a corresponding skill achievement, and determines if the required skill movement matches the player initiated skill movement.

In method step 414, the gaming controller 18 allows the player to obtain the skill achievement if the initiated skill movement matches the required skill movement, and responsively provide an award to the player as a function of the obtained skill achievement. Upon obtaining the skill achievement, the gaming controller 18 may provide an award including an amount of credits for use in placing wagers in the primary wagering game 60 and credit the amount to the corresponding credit meter.

In method step 416, the gaming controller 18 does not allow the player to obtain the skill achievement if the initiated skill movement does not match the required skill movement. In one embodiment, the gaming controller 18 may terminate the skill-based game 62 and displays the primary wagering game 60, upon determining that the initiated skill movement does not matches the required skill movement. In addition, if the player has a number of remaining skill movements for use in the skill-based game 62, the gaming controller 18 may continue to allow the player to play the secondary skill-based game 62 until the player does not have any remaining skill movements. In addition, the gaming controller 18 may also terminate the skill-based game 62 upon receiving a corresponding termination signal from the player. For example, in one embodiment, after each use of the skill movement, the gaming controller 18 may prompt the player to place an addition wager to receive an additional skill movement for use in obtaining a skill achievement. If the gaming controller 18, does not receive the requested wager within a predefined period of time, the gaming controller 18 may terminate the secondary skill-based game 62 and display the primary wagering game 60 to the player.

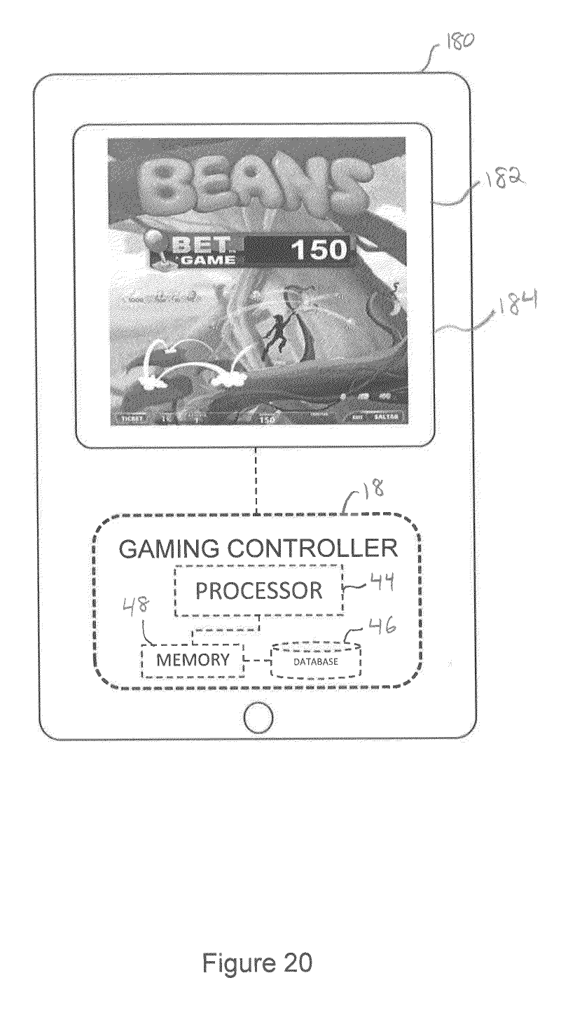

FIG. 20 is a schematic representation of a gaming device 180 for allowing a player to play the bingo-type game 60 including the secondary skill-based game 62, according to an embodiment of the invention. The gaming device 180 may be a smartphone, a personal computer, laptop, cell phone, tablet computer, smartphone/tablet computer hybrid, personal data assistant, and/or any suitable computing device that displays the graphical interfaces 116 and enables the user to play the primary game 60 and/or the secondary game 62. In the illustrated embodiment, the gaming device 180 includes a display device 182 such as, for example, display device 14, a user input device 184 such as, for example, user input device 16, and the gaming controller 18 coupled to the display device 14 and the user input device 16.

The gaming controller 18 includes the processor 44 and the memory device 48 that is coupled to the processor 44. The memory device 48 stores programs and information used by the processor 44 including, but not limited to, image data for producing images and/or screens on the display device 14, game indicia, symbol weights, paytables, and/or winning combination tables which represent relationships between combinations of random numbers, combinations of symbol matches and types of awards associated with the bingo-type game 60 and the secondary game 62.

The processor 44 includes a computer readable medium, such as, without limitation, random access memory (RAM), read-only memory (ROM), erasable programmable read-only memory (EPROM), flash memory, a hard disk drive, a solid state drive, a diskette, a flash drive, a compact disc, a digital video disc, and/or any suitable device that enables the gaming controller 18 to store, retrieve, and/or execute instructions and/or data. The gaming controller x in particular executes a game program to implement the method 400 and thereby conducts a game in accordance with the embodiments described herein.

The invention overcomes at least some of the disadvantages of known gaming machines by providing, among other things, systems and methods which enable a player to place a wager on a skill-based game and receive an award that may be used to place a wager on another non-skill based game, namely a primary wagering game or just wagering game. The primary wagering game award includes an amount of wagering credits and a secondary skill-based game triggering condition that is defined as a predefined amount of wagering credits being accumulated during the primary game. A plurality of game symbols are displayed on the display device and the triggering condition may be defined as an appearance of a special symbol in the primary game outcome and wagering credits. The wagering credits may be used in the secondary skilled-based game and/or on a betting game related to the secondary skilled-based game.

The method described herein allows a player to play a game on a gaming device that includes a processor in communication with a display device. The method includes the steps of: a.) allowing a player to make a wager associated with a primary wagering game and responsively displaying the primary wagering game on the display device; b.) generating an outcome of the primary wagering game and providing a primary game award to the player as a function of the primary wagering game outcome; and c.) displaying an option to trigger a secondary skill-based game on the display device once the primary wagering game outcome reaches a threshold value. The secondary skill-based game may include a platform game that allows the player to move at least one selectable character through at least one vertically arranged level by sending a command wherein said command comprises a reduction in the wagering outcome.

The secondary skill-based game may also include randomly generated items along the levels. These items may include wagering credits. The items are intended for providing a wagering outcome comprised in an item when the selectable character contacts the item.

The betting game may include: a.) betting on the content of an item, wherein each item of the plurality of items may be associated with a different characteristic of simulated movement; b.) opening the item; and c.) collecting wagering credits contained in the item.

The secondary skill-based game depicted in FIGS. 1 and 16-19 appears on screen when it is determined that a triggering condition occurs in the primary wagering game outcome. the secondary skill-based game starts on the occurrence of the triggering condition. The secondary skill-based game may be stopped if a player selection input indicative of a player's selection of the character movement is not received within an elapsed predefined period of time since the player's selection of the player selectable item.

The system may also include a controller that is coupled to the display device and the user input device. The controller is configured to allow a player to make a wager associated with a primary wagering game, display the primary wagering game on the display device, randomly generate an outcome of the primary wagering game, and provide a primary game award to the player as a function of the primary wagering game outcome. The controller may also display a secondary skill-based game on the display device. The secondary skill-based game includes a plurality a plurality of platforms and a plurality of player-selectable items for use in contacting the plurality of platforms. The controller may allow the player to select at least one item from the plurality of player-selectable items, allow the player to select a movement associated with the selected item, determine an outcome of the secondary skill-based game as a function of the selected item and the selected item movement, and display the secondary skill-based game outcome including a simulated movement of the selected item in which the selected item is displayed as either contacting a platform or not contacting a platform.

In one embodiment, the controller may be further operative for providing a secondary game award to the player as a function of the secondary skill-based game outcome. The secondary game award includes wagering credits for use in placing a wager in the primary game. The controller may determine if a triggering condition occurs in the primary game outcome and responsively display the secondary skill-based game based on the occurrence of the triggering condition. The triggering condition may be defined as a predefined amount of wagering credits being accumulated during the primary game.

In an alternative embodiment the controller may also be operative for allowing the player to purchase an item of the plurality of player selectable items and displaying the secondary skill-based game with the purchased item.

In one embodiment, in order to play the game on a gaming device, the gaming device includes a processor in communication with a display device. The method to play game comprises the steps of: a.) allowing a player to make a wager associated with a skill-based game and responsively displaying the skill-based game on the display device, the skill-based game including a plurality a plurality of platforms and a plurality of player-selectable items for use in contacting the plurality of platforms; b.) allowing the player to purchase at least one item from the plurality of player-selectable items using the wager; c.) allowing the player to select a movement associated with the selected item; d.) determining an outcome of the skill-based game as a function of the purchased item and the selected item movement; e.) displaying the skill-based game outcome including a simulated movement of the selected item in which the selected item is displayed as either contacting a platform or not contacting a platform; and f.) providing an award to the player as a function of the skill-based game outcome.

For example, the system and methods of the invention are configured to allow the player to play a slot machine-type or bingo wagering game that includes a bonus feature namely the secondary skill-based game. The skill-based game allows the player to receive an enhanced award based on the outcome of the skill-based game plus a bet-on-game included in the secondary game. More specifically, the system and methods of the present invention allow the player to place a wager on the outcome of the skill-based game, interact with the skill-based game to affect the game outcome, and provide an award to the player based on the outcome of the skill-based game and the player's wager. In addition, the player may place a wager on the bingo-type game using the award provided in the skill-based game. By providing a bingo-type game that includes a bonus feature skill-based game that provides an award to the player that may be used for wagering on the bingo-type game, the player's expectation for achieving a win is increased and the enjoyment of the game is improved. Thus, the amount of time that the game is played by patrons of a gaming establishment is thereby increased.

The above-described systems and methods overcome at least some disadvantages of known gaming machines by providing a system that allows a player to place a wager on a skill-based game, allows the player to affect the outcome of the game via skill-based player selections, and provides an award to the player based on the wager, the game outcome, and a paytable. In addition, the system and methods of the invention are configured to allow the player to play a bingo-type wagering game that includes a bonus feature skill-based game and that allows the player to receive an enhanced award based on the outcome of the skill-based game. By providing a bingo-type game that includes a bonus feature skill-based game that provides an award to the player that may be used for wagering on the bingo-type game, the player's expectation for achieving a win is increased and the enjoyment of the game is improved. Thus, the amount of time that the game is played by patrons of a gaming establishment is thereby increased.

Exemplary embodiments of a gaming machine, a gaming system, and a method of allowing a player to play a game on a gaming machine are described above in detail. The gaming machine, system, and method are not limited to the specific embodiments described herein, but rather, components of the gaming machine and/or system and/or steps of the method may be utilized independently and separately from other components and/or steps described herein. For example, the gaming machine may also be used in combination with other gaming systems and methods, and is not limited to practice with only the gaming machine as described herein. Rather, an exemplary embodiment can be implemented and utilized in connection with many other gaming system applications.

A controller, computing device, or computer, such as described herein, includes at least one or more processors or processing units and a system memory. The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Other aspects and features of the present invention can be obtained from a study of the drawings, the disclosure, and the appended claims. The invention may be practiced otherwise than as specifically described within the scope of the appended claims. It should also be noted, that the steps and/or functions listed within the appended claims, notwithstanding the order of which steps and/or functions are listed therein, are not limited to any specific order of operation.

Although specific features of various embodiments of the invention may be shown in some drawings and not in others, this is for convenience only. In accordance with the principles of the invention, any feature of a drawing may be referenced and/or claimed in combination with any feature of any other drawing.

What is claimed is:

1. A gaming machine for providing a skill-based game to a player, comprising:
a display device for displaying a game to a player, the game including a primary wagering game and a secondary skill-based game; and
a controller coupled to the display device, the controller configured to:
randomly generate a primary game outcome of the primary wagering game and display the primary game outcome on the display device;
detect a triggering condition during the primary wagering game and responsively display the secondary skill-based game;
receive a wager being associated with the secondary skill-based game from the player;
receive a skill input from the player and responsively generate a secondary game outcome of the secondary skill-based game as a function of the received skill input; and
provide an award to the player as a function of the secondary game outcome, the award including wagering credits for use in placing a wager in the primary wagering game.

2. A gaming machine in accordance with claim 1, the controller configured to:
display the skill-based game including a plurality of skill achievements;
determine if the player obtains the skill achievement as a function of the skill input; and
responsively provide the award to the player as a function of the obtained skill achievement.

3. A gaming machine in accordance with claim 1, the secondary skill-based game including a character being movable by the player via a plurality of skill inputs, the character being adapted to perform at least one skill movement in response to the received skill input, the character being movable through a playing field and being able to obtain the plurality of skill achievements positioned within the playing field.

4. A gaming machine in accordance with claim 3, the secondary skill-based game including a plurality of platforms, a corresponding skill achievement being defined as the character landing on a first platform of the plurality of platforms, the corresponding skill achievement being obtained when the character jumps from another platform and lands on the first platform.

5. A gaming machine in accordance with claim 3, the controller configured to allow the player to select the at least one skill movement from the plurality of skill movements for obtaining a skill achievements, the plurality of skill movements including a first skill movement being associated with a first wager amount and a second skill movement being associated with a second wager amount that is different from the first wager amount.

6. A gaming machine in accordance with claim 3, the secondary skill-based game including a plurality of characters, each of the characters being selectable by the player for use in the secondary skill-based game, the controller configured to:
assign a wager amount to each of the player selectable characters;
select one of the player selectable characters;
receive a wager equal to the wager amount associated with the selected character; and
display the selected character in the secondary skill-based game for use by the player.

7. A gaming machine in accordance with claim 3, the secondary skill-based game including at least one bonus symbol being displayed in the playing field, the controller configured to:
determine if the character selects the bonus symbol, the selected bonus symbol being associated with a plurality of bonus awards;
randomly select at least one of the bonus awards being associated with the selected bonus symbol; and
responsively provide the at least one bonus award to the player.

8. A method of providing a skill-based game to a player via a gaming machine including a display device and a processor, including the steps of comprising:
displaying a game to a player via the display device, the game including a primary wagering game and a secondary skill-based game;
randomly generating a primary game outcome of the primary wagering game by the processor and displaying the primary game outcome on the display;
detecting a triggering condition during the primary wagering game and responsively displaying the secondary skill-based game;
receiving a wager being associated with the secondary skill-based game from the player;
receiving a skill input from the player and responsively generating a secondary game outcome of the secondary skill-based game as a function of the received skill input; and
providing an award to the player as a function of the secondary game outcome, the award including wagering credits for use in placing a wager in the primary wagering game.

9. A method in accordance with claim 8, including the steps of:
displaying the skill-based game including a plurality of skill achievements;
determining if the player obtains the skill achievement as a function of the skill input; and
responsively providing the award to the player as a function of the obtained skill achievement.

10. A method in accordance with claim 8, including the step of displaying the secondary skill-based game including a character being movable by the player via a plurality of skill inputs, the character being adapted to perform at least one skill movement in response to the received skill input, the character being movable through a playing field and being able to obtain the plurality of skill achievements positioned within the playing field.

11. A method in accordance with claim 10, including the step of displaying the secondary skill-based game including a plurality of platforms, a corresponding skill achievement being defined as the character landing on a first platform of the plurality of platforms, the corresponding skill achievement being obtained when the character jumps from another platform and lands on the first platform.

12. A method in accordance with claim 10, including the steps of allow the player to select the at least one skill movement from the plurality of skill movements for obtaining a skill achievements, the plurality of skill movements including a first skill movement being associated with a first wager amount and a second skill movement being associated with a second wager amount that is different from the first wager amount.

13. A method in accordance with claim 10, including the steps of:
displaying the secondary skill-based game including a plurality of characters, each of the characters being selectable by the player for use in the secondary skill-based game;
assigning a wager amount to each of the player selectable characters;
selecting one of the player selectable characters;
receiving a wager equal to the wager amount associated with the selected character; and
displaying the selected character in the secondary skill-based game for use by the player.

14. A method in accordance with claim 10, including the steps of:
displaying the secondary skill-based game including at least one bonus symbol being displayed in the playing field;
determining if the character selects the bonus symbol, the selected bonus symbol being associated with a plurality of bonus awards;
randomly selecting at least one of the bonus awards being associated with the selected bonus symbol; and
responsively providing the at least one bonus award to the player.

15. One or more non-transitory computer-readable storage media, having computer-executable instructions embodied thereon, wherein when executed by at least one processor, the computer-executable instructions cause the processor to:
display a game to a player via a display device, the game including a primary wagering game and a secondary skill-based game;
randomly generate a primary game outcome of the primary wagering game and display the primary game outcome;
detect a triggering condition during the primary wagering game and responsively display the secondary skill-based game;
receive a wager being associated with the secondary skill-based game from the player;
receive a skill input from the player and responsively generate a secondary game outcome of the secondary skill-based game as a function of the received skill input; and
provide an award to the player as a function of the secondary game outcome, the award including wagering credits for use in placing a wager in the primary wagering game.

16. The one or more computer-readable storage media according to claim 15, wherein when executed by at least one processor, the computer-executable instructions cause the processor to:
display the skill-based game including a plurality of skill achievements;
determine if the player obtains the skill achievement as a function of the skill input; and
responsively provide the award to the player as a function of the obtained skill achievement.

17. The one or more computer-readable storage media according to claim 15, wherein when executed by at least one processor, the computer-executable instructions cause the processor to display the secondary skill-based game including a character being movable by the player via a plurality of skill inputs, the character being adapted to perform at least one skill movement in response to the received skill input, the character being movable through a playing field and being able to obtain the plurality of skill achievements positioned within the playing field.

18. The one or more computer-readable storage media according to claim 17, wherein when executed by at least one processor, the computer-executable instructions cause the processor to allow the player to select the at least one skill movement from the plurality of skill movements for obtaining a skill achievements, the plurality of skill movements including a first skill movement being associated with a first wager amount and a second skill movement being associated with a second wager amount that is different from the first wager amount.

19. The one or more computer-readable storage media according to claim 17, wherein when executed by at least one processor, the computer-executable instructions cause the processor to:
display the secondary skill-based game including a plurality of characters, each of the characters being selectable by the player for use in the secondary skill-based game;
assign a wager amount to each of the player selectable characters;
select one of the player selectable characters;
receive a wager equal to the wager amount associated with the selected character; and
display the selected character in the secondary skill-based game for use by the player.

20. The one or more computer-readable storage media according to claim 17, wherein when executed by at least one processor, the computer-executable instructions cause the processor to:
display the secondary skill-based game including at least one bonus symbol being displayed in the playing field;
determine if the character selects the bonus symbol, the selected bonus symbol being associated with a plurality of bonus awards;
randomly select at least one of the bonus awards being associated with the selected bonus symbol; and
responsively provide the at least one bonus award to the player.
